(19) United States
(12) Patent Application Publication
(10) Pub. No.: US 2009/0187562 A1
(43) Pub. Date: Jul. 23, 2009

(54) SEARCH METHOD

(75) Inventors: Tatsuya ASAI, Kawasaki (JP); Shinichiro Tago, Kawasaki (JP); Seishi Okamoto, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/357,423

(22) Filed: Jan. 22, 2009

(30) Foreign Application Priority Data
Jan. 22, 2008 (JP) 2008-011679

(51) Int. Cl. G06F 17/30

(52) U.S. Cl. 707/5; 707/3; 707/E17.014; 707/E17.008

(57) ABSTRACT

A search method for causing a computer to execute the search method of searching for and retrieving, when a search formula to document data having a hierarchy structure whose elements are delimited by an element identifier is obtained, data corresponding to the search formula from the document data, stores, when the search formula is obtained, the search formula to a memory device; determines, when the data corresponding to the search formula is searched for and retrieved from the document data, whether or not a hierarchy management is necessary to the search formula based on the search formula; and searches for and retrieves, when the hierarchy management is not necessary to the search formula, the document data corresponding to the search formula without executing the hierarchy management.

### CROSS-REFERENCE TO RELATED APPLICATIONS

This application is based upon and claims the benefit of priority of the prior Japanese Patent Application No. 2008-11679, filed on Jan. 22, 2008, the entire contents of which are incorporated herein by reference.

### FIELD

The present invention relates to a search method of a search apparatus for searching for and retrieving data corresponding to a search formula from document data when the search formula for the document data, which has a hierarchy structure whose elements are delimited by element identifiers, is obtained.

### BACKGROUND

Recently, markup languages such as XML (Extensible Markup Language) are used as document data processed by a computer. The XML has been more and more widely used by computers in many cases because it permits structured documents and structured data to be easily shared between different information systems, in particular through the Internet (hereinafter, document data having a hierarchy structure described based on XML is referred to as “XML data”).

An X-Path (XML Path Language) query is used to designate a specific check position of the XML data (hereinafter, referred to as “query”. The query is a standard query language for the XML data and has a capability for describing a search formula for a complex XML tree structure. There are, for example, the following techniques for detecting data in the XML data based on such a query.

Document L. Qin, J. X. Yu, B. Ding, “Twig List: Make Twig Pattern Matching Fast”, Proc. of DASFAA′ 07, 850-862, LNCS4443, Springer-Verlag discloses a technique for detecting the position of a final reply by constructing a hierarchy list for evaluating an X-Path (query) by scanning XML data and scanning a constructed hierarchy list structure to determine a combination of check positions of X-path in the XML data. Furthermore, Japanese Laid-open Patent Publication No. 2004-326578 discloses a technique for evaluating a query while sequentially creating document trees from the XML data.

### SUMMARY

The present invention provides a method of causing a computer to execute a search method for searching, when a search formula to document data having a hierarchy structure whose elements are delimited by an element identifier is obtained, data corresponding to the search formula from the document data, including

a storage step of storing, when the search formula is obtained, the search formula in a memory device;

a determination step of determining, when searching for the data corresponding to the search formula from the document data, whether or not a search formula is one that requires hierarchy management based on the search formula; and

a search step of searching, when it is determined by the determination step that the hierarchy management is not necessary for the search formula, for the data corresponding to the search formula from the document data without executing the hierarchy management.

### BRIEF DESCRIPTION OF THE DRAWINGS

FIG. 1 is a diagram showing an example of a data structure of XML data;

FIG. 2 is a diagram showing an example of a tree representation of the XML data;

FIG. 3 is a diagram explaining data to a query;

FIG. 4 is a functional block diagram showing a configuration of a search apparatus according to an embodiment 1;

FIG. 5 is a diagram showing an example of a data structure of a path ID table;

FIG. 6 is a diagram showing an example of a data structure of BIN data;

FIG. 7 is a diagram explaining a data structure of a step structural body;

FIG. 8 is a diagram (1) showing an example of a query tree;

FIG. 9 is a diagram (2) showing an example of a query tree;

FIG. 10 is a diagram showing an example of a data structure of an event definition table;

FIG. 11 is a diagram showing an example of a data structure of an event table;

FIG. 12 is a diagram explaining a process of a BIN data creation unit;

FIG. 13 shows diagrams on explaining the number of leaves of a query tree;

FIG. 14 shows diagrams showing an example of a query which belongs to a difficult class with the number of leaves being “2”;

FIG. 15 is a diagram explaining a process of an event table creation unit;

FIG. 16 is a diagram explaining a process of an event table totaling unit;

FIG. 17 is a flowchart showing a processing sequence of the search apparatus according to the embodiment 1;

FIG. 18 is a flowchart showing a main procedure of a query class determination process;

FIG. 19 is a flowchart showing an auxiliary procedure of the query class determination process;

FIG. 20 is a flowchart showing a processing sequence of an event table creation process;

FIG. 21 is a flowchart showing a processing sequence of an event totaling process;

FIG. 22 is a functional block diagram showing a configuration of a search apparatus according to an embodiment 2;

FIG. 23 is a diagram showing an example of a data structure of an event definition table according to the embodiment 2;

FIG. 24 is a diagram showing an example of a data structure of an event table according to the embodiment 2;

FIG. 25 is a diagram showing an example of a data structure of an automaton of a query according to the embodiment 2;

FIG. 26 is a diagram explaining a process of an event table creation unit according to the embodiment 2;

FIG. 27 is a diagram explaining a process of an event table totaling unit according to the embodiment 2;

FIG. 28 is a functional block diagram showing a configuration of a search apparatus according to an embodiment 3;

FIG. 29 is a diagram explaining a data structure of a step structural body according to the embodiment 3;

FIG. 30 is a diagram (1) showing an example of a query tree according to the embodiment 3;

FIG. 31 is a diagram (2) showing an example of the query tree according to the embodiment 3;

FIG. 32 is a diagram showing an example of a data structure of an event definition table according to the embodiment 3;

FIG. 33 is a diagram showing an example of a data structure of an event table according to the embodiment 3;

FIG. 34 is a diagram explaining the number of leaves of a subtree;

FIG. 35 is a diagram showing an example of a data structure of an automaton of a query according to the embodiment 3;

FIG. 36 is a diagram explaining a process of an event table creation unit according to the embodiment 3;

FIG. 37 is a diagram explaining a process of a query conversion processing unit;

FIG. 38 is a diagram explaining a process of an event table totaling unit according to the embodiment 3;

FIG. 39 is a diagram explaining a height of a query tree;

FIG. 40 is a functional block diagram showing a configuration of a search apparatus according to an embodiment 4;

FIG. 41 is a flowchart showing main procedure of a query class determination process according to the embodiment 4;

FIG. 42 is a flowchart showing an auxiliary procedure of the query class determination process according to the embodiment 4;

FIG. 43 is a functional block diagram showing a configuration of a search apparatus according to an embodiment 5;

FIG. 44(A) is a flowchart (1) showing a main procedure of a query class determination process according to the embodiment 5;

FIG. 44(B) is a flowchart (2) showing a main procedure of the query class determination process according to the embodiment 5;

FIG. 45 is a flowchart showing an auxiliary procedure of the query class determination process according to the embodiment 5; and

FIG. 46 is a diagram showing a hardware configuration of a computer constituting the search apparatus according to the embodiment 1.

### DETAILED DESCRIPTION OF THE EMBODIMENTS

When a check position of a query is determined from the XML data using the known techniques described above in the part of background, a problem arises in that a hierarchy management having a large processing load must be executed. In the hierarchy management, a load on an apparatus is increased because the same position must be read repeatedly to monitor a hierarchy between nodes to be noted by an input query in the XML data as well as to search for a combination of check positions corresponding to the query.

That is, it is a challenge to determine a check position of a query from the XML data without executing a hierarchy management having a heavy process.

An aspect of the present invention, which was made to address the above problems of the conventional techniques described above, is to provide a search method capable of determining a check position of a query from the XML data without executing, as much as possible, a hierarchy management having a heavy process.

According to the search method, when a search apparatus obtains a search formula, the search formula is stored in a memory device and data corresponding to the search formula is searched for and retrieved from document data, whether or not a hierarchy management is necessary for the search formula is determined based on the search formula. When the hierarchy management is determined to be unnecessary for the search formula, since data corresponding to the search formula can be searched for and retrieved from the document data without executing the hierarchy management, data search efficiency can be improved by reducing a load applied on an apparatus according to a query.

Furthermore, according to the search method, when the hierarchy management is determined to be unnecessary for a search formula, binary data is created in which the respective element identifiers included in document data are converted into unique identification information, and whether or not the binary data coincides with the search formula is determined. As a result, since data corresponding to the search formula can be searched for and retrieved from the document data, a load applied on the apparatus can be reduced and a check position of a query can be detected at a high speed.

Furthermore, according to the search method, when a tree structure of a search formula has one terminal node, the hierarchy management is determined to be unnecessary. As a result, whether or not the hierarchy management is necessary can be accurately determined.

Furthermore, according to the search method, since the hierarchy management is determined to be unnecessary when a tree structure of a search formula has two terminal nodes, and since a node connected by a pointer of a terminal node acting as a second step does not exist, whether or not the hierarchy management is necessary can be accurately determined.

Furthermore, according to the search method, the number of nodes included in the longest path of the search formula may be determined, and the hierarchy management is determined to be unnecessary when the number of nodes is equal to or less than a given value. As a result, whether or not a query belongs to an easy class can be effectively determined, and a load applied on an apparatus can be reduced.

Embodiments of a search method according to the present invention will be explained below in detail referring to the attached drawings.

### Embodiment 1

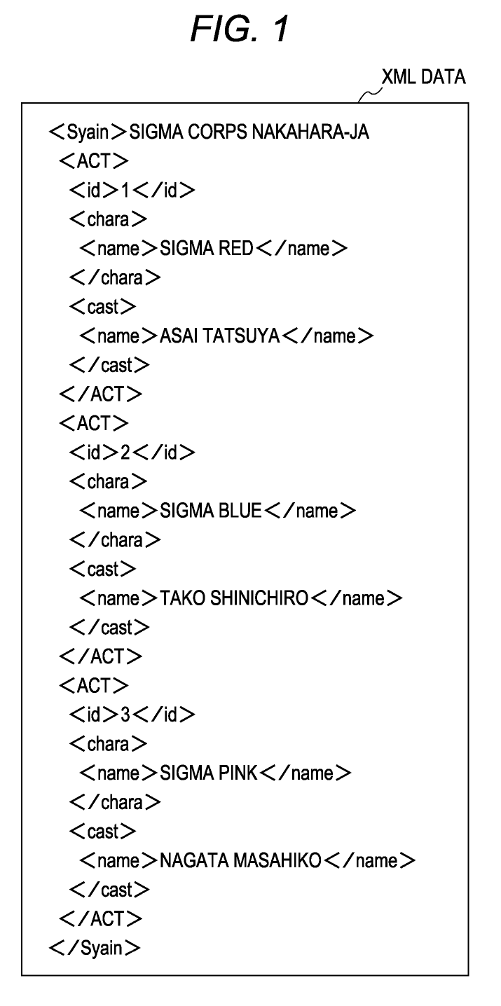

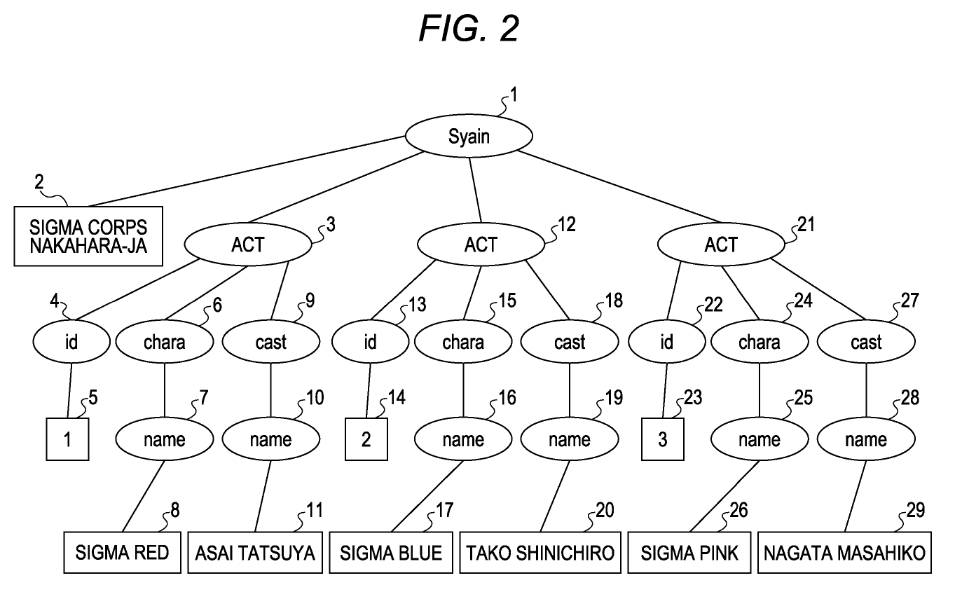

First, embodiment 1 will be explained using XML (Extensible Markup Language) data. FIG. 1 is a diagram showing a data structure of the XML data. As shown in the diagram, the XML data has a hierarchy structure whose elements are delimited by element identifiers “<”, “</”, and the like. A tree representation of the XML data of FIG. 1 is shown in FIG. 2.

FIG. 2 is a diagram showing an example of the tree representation of the XML data in FIG. 1. As shown in the drawing, in the tree representation of the XML data, the XML data has element nodes of node IDs 1, 3, 4, 6, 7, 9, 10, 12, 13, 15, 16, 18, 19, 21, 22, 24, 25, 27, and 28 and text nodes of node IDs 2, 5, 8, 11, 14, 17, 20, 23, 26, and 29. The XML data also connects the respective element nodes and the respective text nodes. For example, element node Syain 1 is connected to text node “sigma corps nakahara-ja” 2 and to element nodes “ACT”s 3, 12, and 21.

Data of a check position of a query can be obtained from the XML data by designating an X-Path (XML Path Language) query (hereinafter, referred to as query). Note that a subset of a query by W3C (World Wide Web Consortium) is defined as: Path::=“/”RPathRPath::=Step(“/”Step)*Step::=Axis“::”Ntest(“[“Pred”]”)? (where “?” denotes zero repetitions or one repetition), Axis::=“child”Ntest::=tagname|“*”|“text( )”|“node( )”Pred::=ExprExpr::=RPath

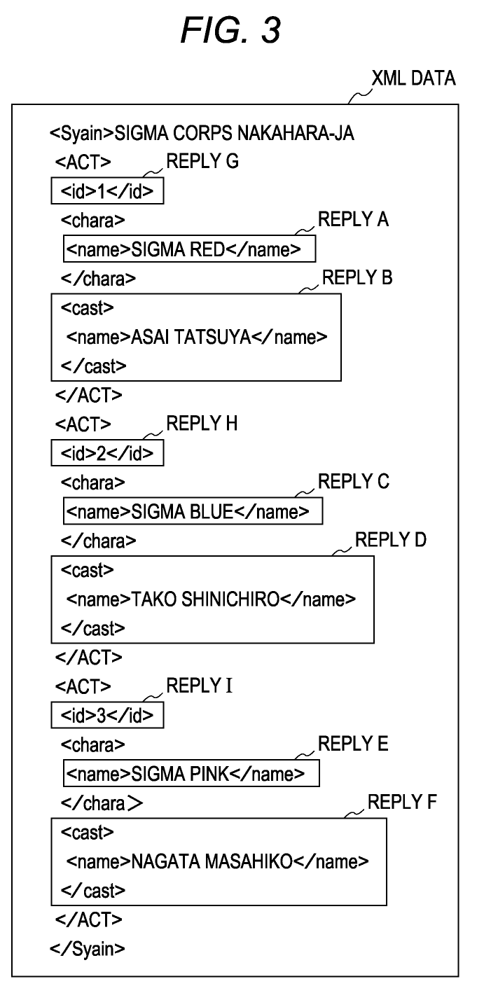

When, for example, a query is designated as “Q1=/Syain/ACT/chara/name”, the data of element node names 7, 16, and 25 (refer to FIG. 2) denoted by “/Syain/ACT/chara/name” are obtained (refer to replies A, C, E of FIG. 3; FIG. 3 is a diagram explaining data of a query).

Furthermore, when a query is designated as “Q2=/Syain/ACT[chara/name]/cast”, the data of element nodes “cast” 9, 18, and 27 (refer to replies B, D, F of FIG. 3), which are connected to “ACT” 3, 12, and 21 having “chara/name” as child element nodes are obtained. Note that it is assumed that a query used in embodiment 1 has only a child axis and does not include an axis in a brother's direction.

Next, a search apparatus according to embodiment 1 will be explained. When the search apparatus according to embodiment 1 searches data corresponding to a query from XML data, the search apparatus determines whether or not a hierarchy management is necessary based on the query. When the search apparatus determines that the hierarchy management is not unnecessary for a search formula, the search apparatus searches for and retrieves the data corresponding to the query from the XML data without executing the hierarchy management. As described above, since the search apparatus according to embodiment 1 searches for and retrieves, based on a query, the data from the XML data without executing the hierarchy management having a heavy process, a load applied on the apparatus can be reduced and data search efficiency may be improved.

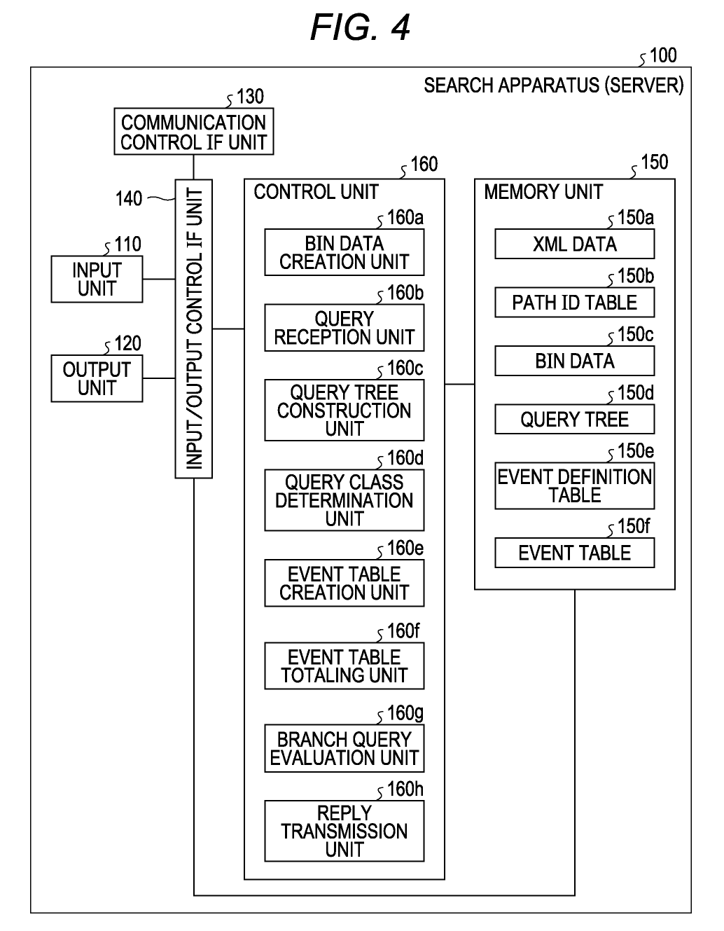

FIG. 4 is a functional block diagram showing a configuration of the search apparatus 100 according to embodiment 1. As shown in the drawing, the search apparatus 100 has an input unit 110, an output unit 120, a communication control IF unit 130, an input/output control IF unit 140, a memory unit 150, and a control unit 160. Note that it is assumed that the search apparatus 100 is connected to a terminal apparatus (not shown) through a network.

The input unit 110 inputs various types of information. The input unit 110 is composed of a keyboard, a mouse, a microphone, and the like, and receives and inputs, for example, various types of information related to the XML data described above. Note that a monitor (output unit 120) to be described below may also act as a pointing device function with the mouse.

The output unit 120 is composed of a monitor (or a display or a touch panel), a speaker, and the like, and outputs, for example, various types of information related to the XML data described above.

The communication control IF unit 130 controls communication between terminal apparatuses. The input/output control IF unit 140 controls data input and output by the input unit 110, the output unit 120, the communication control IF unit 130, the memory unit 150, and the control unit 160.

The memory unit 150 stores data and programs for the control unit 160 to perform various processes, and has XML data 150a, a path ID table 150b, BIN data 150c, a query tree 150d, an event definition table 150e, and an event table 150f as those particularly closely related to the present invention as shown in FIG. 4.

XML data 150a is document data having a hierarchy structure whose elements are delimited by element identifiers “<”, “</”, and the like (refer to FIG. 1) as described above. The path ID table 150b includes data in which a path included in the XML data 150a is associated with a path ID (Identification).

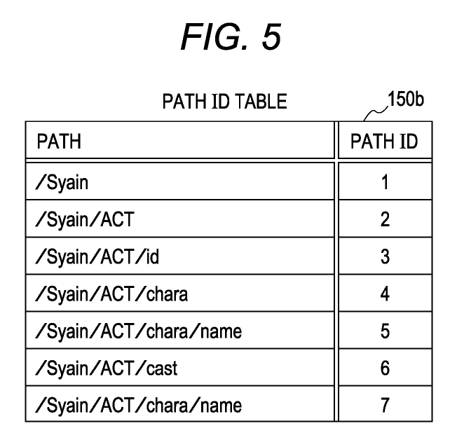

FIG. 5 is a diagram showing an example of a data structure of the path ID table 150b. As shown, in the path ID table 150b, the path is associated with a path ID. For example, a path “/Syain” is associated with the path ID “1”.

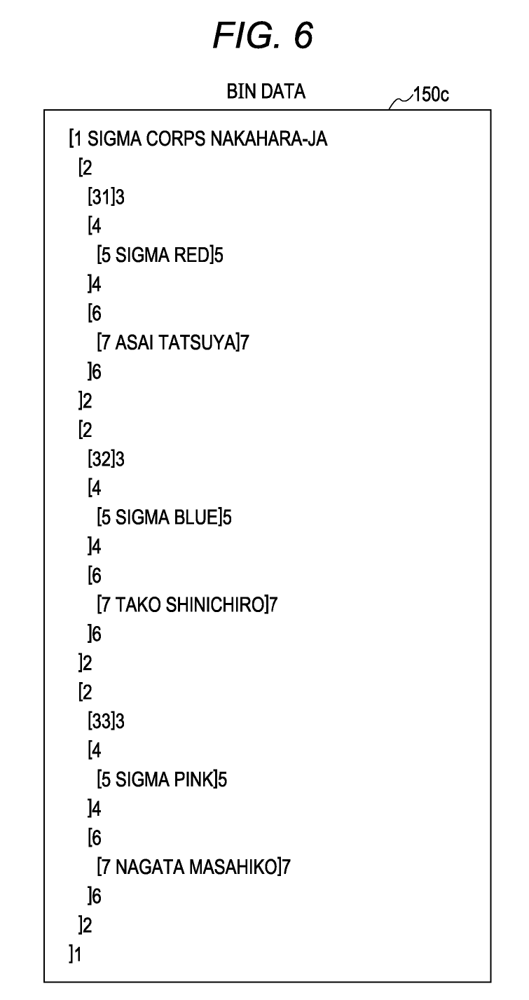

The BIN data 150c is data in which the respective elements included in the XML data 150a are replaced with the path IDs of the path ID table 150b. FIG. 6 is a diagram showing an example of a data structure of BIN data. For example, “<Syain>” of “<Syain> sigma corps nakahara-ja” located at a first stage of the XML data 150a (refer to FIG. 1), is converted into “[1 sigma corps nakahara-ja” as shown by a first stage of the BIN data 150c so that “<Syain>” corresponds to the path “/Syain” (path ID “1”) of the path ID table (refer to FIG. 5). As described above, the management of a tag hierarchy in a path check can be omitted by converting the XML data 150a into the BIN data 150c.

The query tree 150d is data constructed from a query and is composed of a plurality of step structural bodies. Here, a step structural body is shown by a trinomial set of an axis, a tag name, and a predicate (in embodiment 1, only child axes are considered). Then, a query shown as, for example, “/A[B]/C[D or E]/F” has three steps called “A[B]”, “C[D or E]”, and “F”.

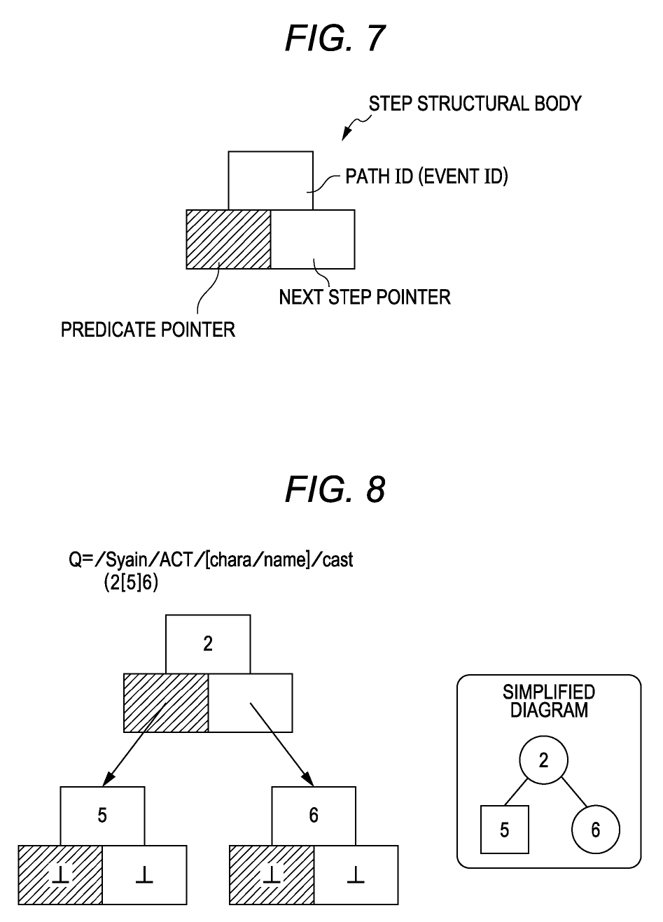

FIG. 7 is a diagram explaining a data structure of a step structural body. As shown in the drawing, the step structural body has a path ID (event ID), a predicate pointer, and a next step pointer. The predicate pointer is a pointer of a step structural body showing the predicate, and the next step pointer is a pointer of a step structural body acting as a next step. Note that a step structural body that acts as a root of a query tree is shown as “Root”, and a step structural body shown by a next step structural body of “Root” is shown as a “second step” of the query tree.

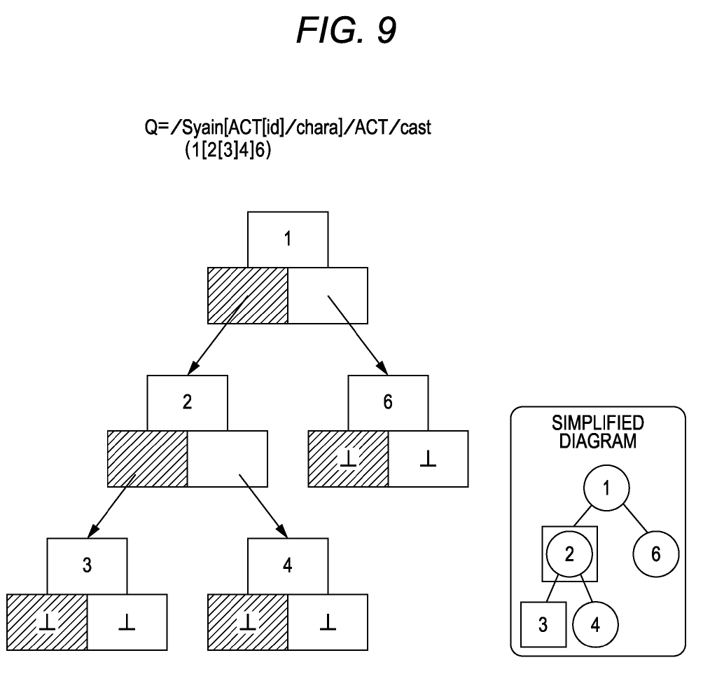

Here, an example of a query tree from a query is shown. FIGS. 8 and 9 are diagrams showing examples of the query tree. The query tree of FIG. 8 is shown by a query “/Syain/ACT/[chara/name]cast” (shown as “2[5]6” when it is shown by a path ID; refer to FIG. 5 as to the path ID). As shown in the diagram, the query tree is composed of step structural bodies of the path IDs “2, 5, 6”, a predicate pointer of the step structural body of the ID path “2” is connected to the step structural body of the path ID “2”, and a next step pointer of the step structural body of the path ID “2” is connected to the step structural body of the path ID “6”.

Then, predicate pointers and next step pointers of the path IDs “5, 6” are set to “Null” (⊥). Here, “Null” shows that no step structural body to be connected exists underneath. In FIG. 8, the step structural body of the path ID “2” acts as “Root”, and the step structural body of the path ID “6” acts as “second step”. Note that the diagram on the right side of FIG. 8 is a simplified diagram of a query tree shown on the left side of FIG. 8.

The query tree of FIG. 9 is shown by the query “/Syain/[ACT[id]/chara]/ACT/cast” (“1[2[3]4]6” when shown by a path ID; refer to FIG. 5 for the path ID). As shown in the diagram, the query tree is composed of step structural bodies of the path ID “1, 2, 3, 4, 6”. A predicate pointer of the step structural body of the path ID “1” is connected to the step structural body of the path ID “2”, and a predicate pointer of the step structural body of the path ID “2” is connected to a step structural body of the path ID “3”.

Furthermore, a next step pointer of the step structural body of the path ID “1” is connected to the step structural body of the path ID “6”, and a next step pointer of the step structural body of the path ID “2” is connected to the step structural body of the path ID “4”. Then, predicate pointers and next step pointers of the path ID 3, 4, 6 are set to “Null”. In FIG. 9, an event structural body of the path ID 1 acts as “Root”, and the step structural body of the path ID “6” acts as “second step”. Note that the diagram on the right side of FIG. 9 is a simplified diagram of the query tree shown on the left side of FIG. 9.

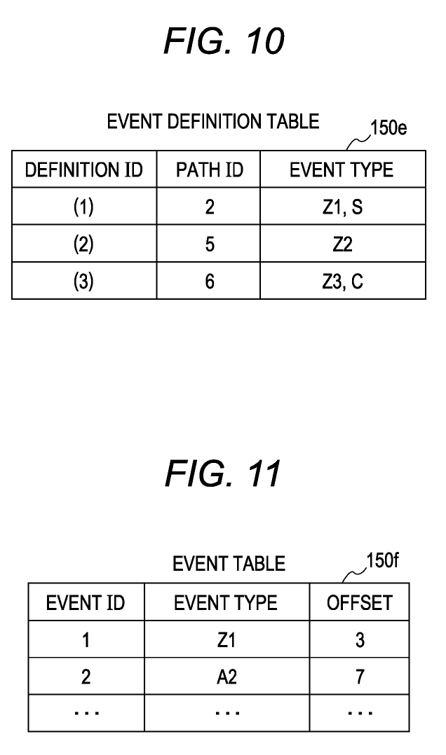

The event definition table 150e shows data in which an event type included in a query is associated with a path ID therein. FIG. 10 is a diagram showing an example of a data structure of the event definition table 150e. As shown in the diagram, the event definition table 150e stores the definition ID, the path ID, and the event type in association with each other. Note that the definition ID is information for identifying a combination of the path ID and the event type.

A set “ETYPE (Q)” acting as the event type has path hit events Z1 to Zn, a query start event S, and a context node event C. Here, the path hit events are events showing that the events hit relevant paths, the query start event is an event showing that the query start event hits a start path of a query, and the context node event is an event showing that the context node event hits an end path of a query.

When, for example, a query is designated as “Q=/Syain/ACT[chara/name]/cast” (“2[5]6” when shown by a path ID), and when a set of event types is designated as “ETYPE(Q)={Z1, Z2, Z3}”, the event definition table 150e shown in FIG. 10 is created.

The event table 150f is a data created based on the BIN data 150c and the event definition table 150e. The event table 150f stores information of the BIN data that corresponds to an event definition in the event definition table 150e. FIG. 11 is a diagram showing an example of a data structure of the event table 150f. As shown in the drawing, the event table 150f stores an event ID, an event type, and an offset in association with each other. The event ID is information for identifying an event, and the offset shows a data position when the event occurs.

The control unit 160 has an internal memory for storing programs that prescribe various processing sequences and for storing control data, and executes various processes. The control unit 160 has a BIN data creation unit 160a, a query reception unit 160b, a query tree construction unit 160c, a query class determination unit 160d, an event table creation unit 160e, an event table totaling unit 160f, a branch query evaluation unit 160g, and a reply transmission unit 160h as those particularly closely related to the present invention as shown in FIG. 4.

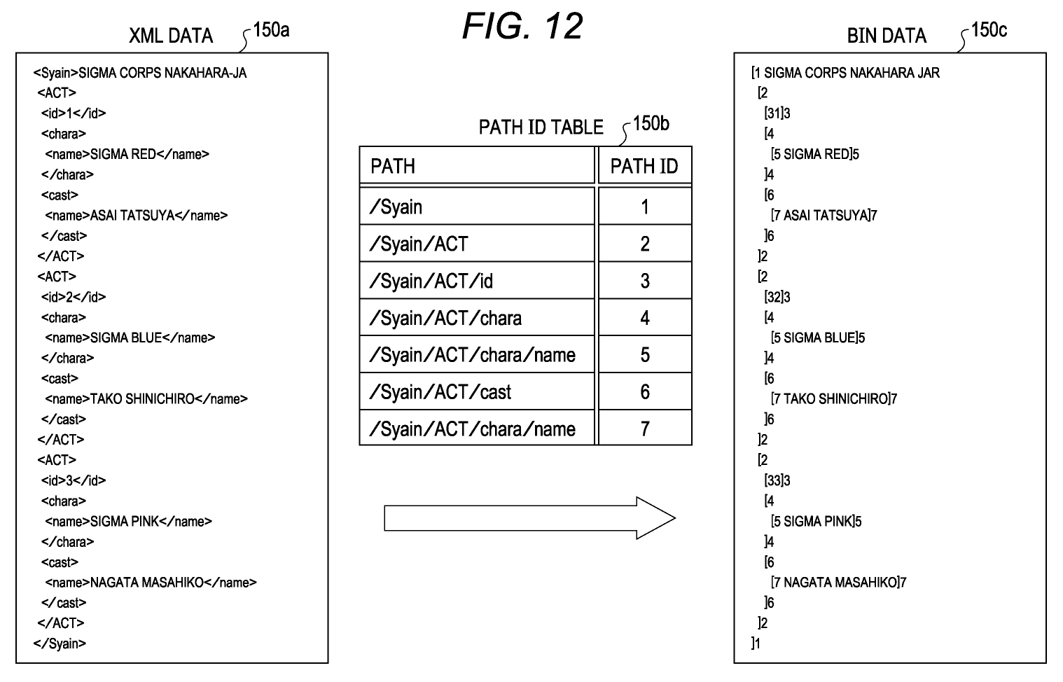

Among them, the BIN data creation unit 160a creates the BIN data by comparing the XML data 150a with the path ID table 150b and replacing respective elements included in the XML data 150a with path IDs. FIG. 12 is a diagram explaining the process of the BIN data creation unit 160a.

For example, the BIN data creation unit 160a arranges a first stage of the BIN data 150c as “[1 sigma corps nakahara-ja” in FIG. 12 since “<Syain>” of “<Syain>sigma corps nakahara-ja” located at a first stage of the XML data 150a corresponds to a path “/Syain” (the path ID “1”) of the path ID table 150b. The BIN data creation unit 160a creates the BIN data 150c by replacing respective elements with the path IDs by likewise comparing the other stages with the path ID table 150b.

The query reception unit 160b receives information on a query from the terminal apparatus through the network. The query reception unit 160b outputs the received information of the query to the query tree construction unit 160c. The query tree construction unit 160c constructs the query tree 150d based on a query (refer to FIGS. 8, 9).

The query class determination unit 160d determines whether or not a query belongs to an easy class or a difficult class based on the query tree. When a query belongs to the easy class, the search apparatus 100 searches data corresponding to the query without executing the hierarchy management. In contrast, when a query belongs to the difficult class, the search apparatus 100 searches data corresponding to the query by executing the hierarchy management as a conventional technique (for example, refer to “TwigList: Make Twig Pattern Matching Fast” above).

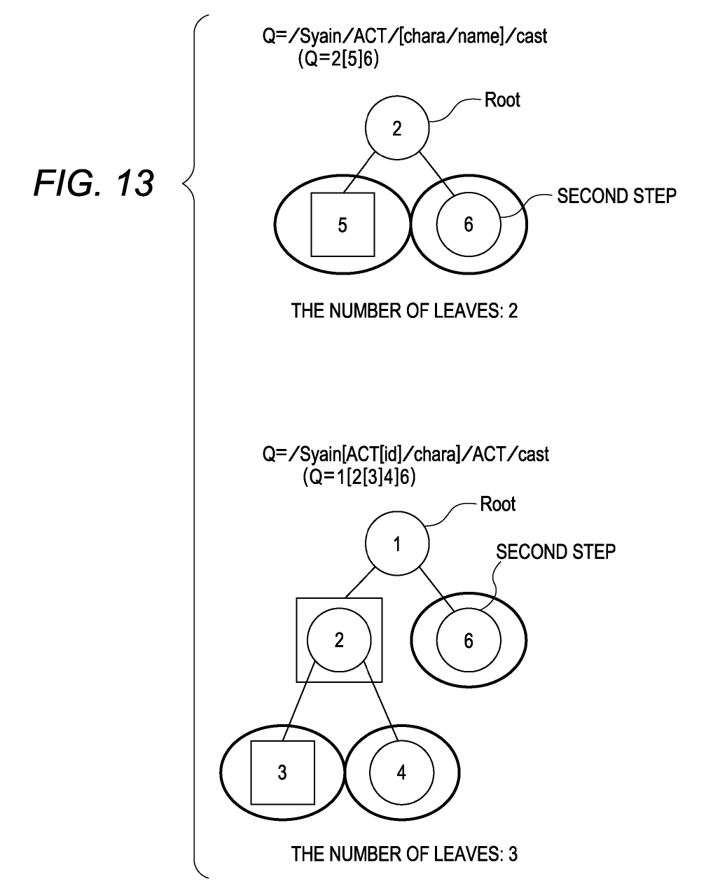

Specifically, the query class determination unit 160d detects the number of leaves of a query tree. Here, “the number of leaves” of a query tree shows the number of leaves in step structural bodies which make up the query tree (refer to FIGS. 8, 9). FIG. 13 shows diagrams explaining the number of leaves of a query tree.

The top diagram of FIG. 13 shows a query tree of a query “/Syain/ACT/[chara/name]/cast”, and the number of leaves is two because the number of terminal nodes (leaves) of the query tree is two. The bottom diagram of FIG. 13 shows a query tree of a query “/Syain[ACT[id]/chara]/ACT/cast”, and the number of leaves is three because the number of terminal nodes (leaves) of the query tree is three.

The query class determination unit 160d determines a query class based on first and second conditions. The first condition is a condition that “a query has one leaf”, and the second condition is a condition that “a query has two leaves, a second step exists, and a predicate pointer and a next step pointer of the second step are both Null”.

When a query is established by any one of the first and second conditions, the query class determination unit 160d determines that the query belongs to the easy class. In contrast, when a query is not established by the first condition or the second condition, the query class determination unit 160d determines that the query belongs to the difficult class.

Here, the query class determination unit 160d will be explained by using FIG. 13. Since the query tree at the top of FIG. 13 has the number of leaves as “2” and the predicate pointer and the next step pointer of the second step are both Null, the second condition is established. Accordingly, the query class determination unit 160d determines that the query “/Syain/ACT/[chara/name]/cast” belongs to the easy class.

Furthermore, since the number of leaves is “3” in the query tree at the bottom of FIG. 13, neither the first condition nor the second condition is established. Accordingly, the query class determination unit 160d determines that the query “/Syain[ACT[id]/chara]/ACT/cast” belongs to the difficult class.

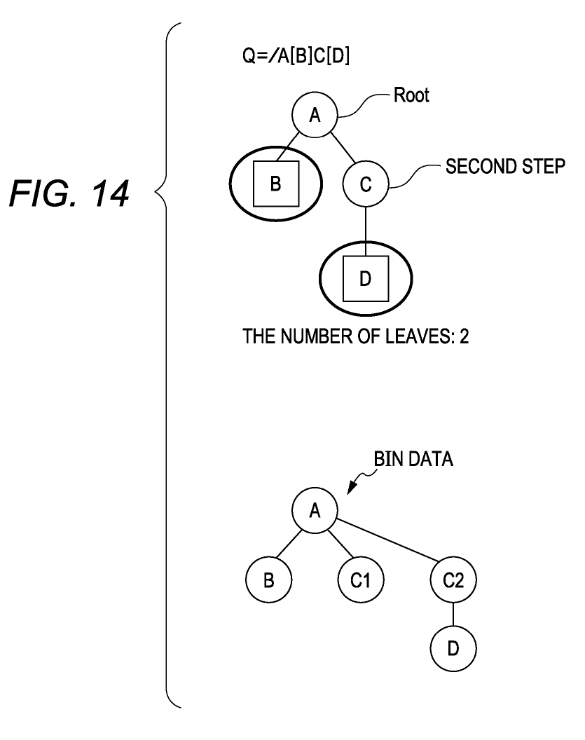

FIG. 14 is a diagram showing an example of a query which belongs to the difficult class even though the number of leaves is “2”. The diagram at the top of FIG. 14 shows a query tree of a query “/A[B]C[D]”. Although the number of leaves of the query tree is “2”, neither the first condition nor the second condition is established because a predicate pointer of the second step is not Null. Accordingly, the query class determination unit 160d determines that the query “/A[B]C[D]” belongs to the difficult class.

When, for example, data corresponding to the query “/A[B]C[D]” is searched for and retrieved from the BIN data shown at the top of FIG. 14, the data cannot be easily evaluated by an evaluation executed only by a logical expression. This is because the presence of D must be managed for each of context candidates (C1 and C2) to correctly calculate that C1 in the BIN data is not a solution (hierarchy management must be executed). Accordingly, the query “/A[B]C[D]” belongs to the difficult class.

The event table creation unit 160e creates the event definition table 150e (refer to FIG. 10) from a query when a result that the query belongs to the easy class is obtained from the query class determination unit 160d. The event table creation unit 160e also creates the event table 150f (refer to FIG. 11) by comparing the BIN data 150c with the event definition table 150e.

First, processing when the event table creation unit 160e creates the event definition table 150e will be explained. When, for example, a query is designated as “Q=/Syain/ACT[chara/name]/cast” (shown as “2[5]6” shown by a path ID) and a set of an event type is designated as “ETYPE(Q)={Z1, Z2, Z3}”, the event table creation unit 160e creates the event definition table 150e shown in FIG. 10 by associating a path ID of the query with a set of event types.

In the conditions described above, the path ID “2” corresponds to the event type “Z1”, the path ID “5” corresponds to the event type “Z2”, and the path ID “6” corresponds to the event type “Z3”. Furthermore, since the path ID “2” is a start path of a query, “S” is included in the event type. Since the path ID “6” is an end path of the query, “C” is included in the event type.

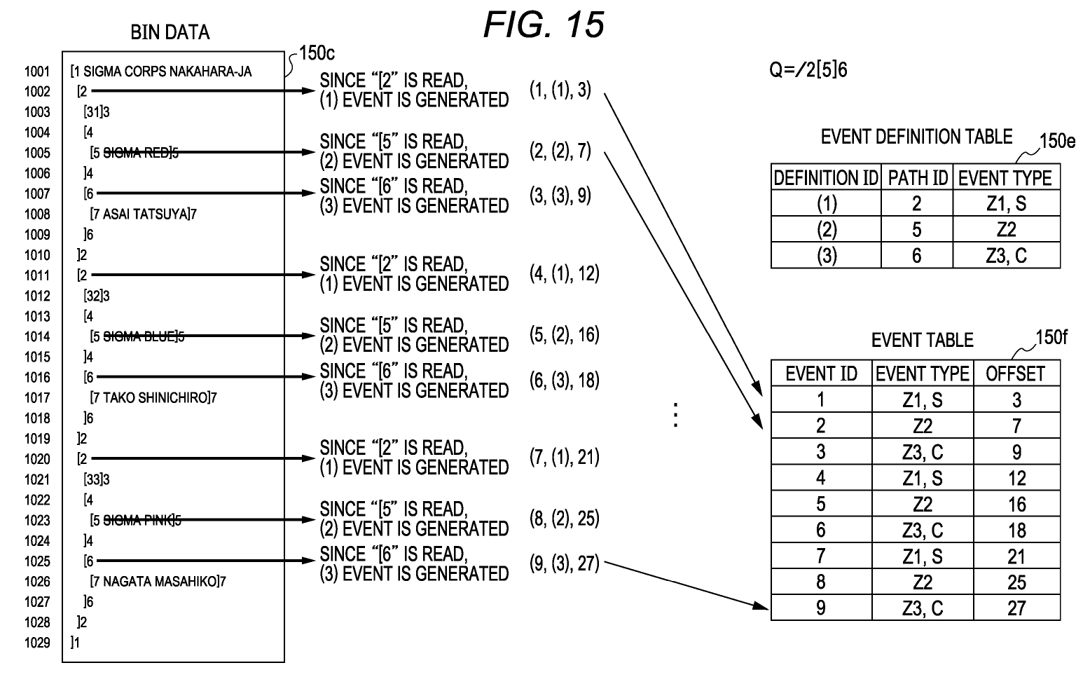

Subsequently, the processing when the event table creation unit 160e creates the event table 150f will be explained. FIG. 15 is a diagram explaining processing of the event table creation unit 160e. The event table creation unit 160e scans the BIN data 150c one character by one character and increments a value of the offset by 1 each time the event table creation unit 160e detects a tag start symbol “[”. Note that, in embodiment 1, a node ID of a node (refer to FIG. 2) when an event occurs is used as a value of the offset for the purpose of explanation.

Furthermore, when the event table creation unit 160e detects a path ID included in the event definition table 150e behind the tag start symbol “[”, the event table creation unit 160e increments ID by 1 and registers a present ID, the event type, and the offset in the event table. In the following description, the processing of the event table creation unit 160e will be explained using FIG. 15.

First, at position “1001” of the BIN data 150c, no path ID included in the event definition table 150e is detected after the tag start symbol “[”. At position “1002” of the BIN data 150c, since a path ID “2” included in the event definition table 150e is detected after the tag start symbol “[”, an event (1) occurs, and the event table creation unit 160e registers the ID “1”, the event types “Z1, S”, and an offset “3” (corresponding to the ACT of the node ID “3” of FIG. 2) in the event table 150f.

At position “1003” of the BIN data 150c, a path ID included in the event definition table 150e is not detected after the tag start symbol “[”. At position “1004” of the BIN data 150c, a path ID included in the event definition table 150e is not detected after the tag start symbol “[”. At position “1005” of the BIN data 150c, the path ID “5” included in the event definition table 150e is detected after the tag start symbol “[”, an event (2) occurs, and the event table creation unit 160e registers an ID “2”, an event type “Z2”, and an offset “7” (corresponding to a name of the node ID “7” of FIG. 2) in the event table 150f.

At position “1006” of the BIN data 150c, no path ID included in the event definition table 150e is detected. At position “1007” of the BIN data 150C, since the path ID “6” included in the event definition table 150e is detected after the tag start symbol “[”, an event (3) occurs, and the event table creation unit 160e registers an event ID “3”, event types “Z3 and C”, and an offset “9” (corresponding to a “cast” of the node ID “9” of FIG. 2) in the event table 150f.

At position “1008” of the BIN data 150c, no path ID included in the event definition table 150e is detected. At position “1009” of the BIN data 150C, no path ID included in the event definition table 150e is detected after the tag start symbol “[”. At position “1010” of the BIN data 150C, no path ID included in the event definition table 150e is detected after the tag start symbol “[”.

At position “1011” of the BIN data 150c, since the path ID “2” included in the event definition table 150e is detected after the tag start symbol “[”, the event (1) occurs, and the event table creation unit 160e registers an event ID “4”, the event types “Z1 and S”, and an offset “12” (corresponding to the ACT of the node ID “12” of FIG. 2) in the event table 150f. At position “1012” of the BIN data 150C, no path ID included in the event definition table 150e is detected after the tag start symbol “[”.

At position of “1013” of the BIN data 150c, no path ID included in the event definition table 150e is detected after the tag start symbol “[”. At position “1014” of the BIN data 150C, since a path ID “5” included in the event definition table 150e is detected after the tag start symbol “[”, an event (2) occurs, and the event table creation unit 160e registers an event ID “5”, the event type “Z2”, and an offset “16” (corresponding to a name of a node ID “16” of FIG. 2) in the event table 150f.

At position of “1015” of the BIN data 150c, no path ID included in the event definition table 150e is detected after the tag start symbol “[”. At position “1016” of the BIN data 150C, since the path ID “6” included in the event definition table 150e is detected after the tag start symbol “[”, the event (3) occurs, and the event table creation unit 160e registers an event ID “6”, the event types “Z3 and C”, and an offset “18” (corresponding to a “cast” of the node ID “18” of FIG. 2) in the event table 150f.

At position “1017” of the BIN data 150c, no path ID included in the event definition table 150e is detected. At position “1018” of the BIN data 150C, no path ID included in the event definition table 150e is detected after the tag start symbol “[”. At position “1019” of the BIN data 150C, no path ID included in the event definition table 150e is detected after the tag start symbol “[”.

At position “1020” of the BIN data 150c, since the path ID “2” included in the event definition table 150e is detected after the tag start symbol “[”, the event (1) occurs, and the event table creation unit 160e registers an event ID “7”, the event types “Z1 and S”, and an offset “21” (corresponding to an ACT of a node ID “21” of FIG. 2) in the event table 150f. At position “1021” of the BIN data 150C, no path ID included in the event definition table 150e is detected.

At position “1022” of the BIN data 150C, no path ID included in the event definition table 150e is detected. At position “1023” of the BIN data 150C, since the path ID “5” included in the event definition table 150e is detected after the tag start symbol “[”, the event (2) occurs, and the event table creation unit 160e registers an event ID “8”, the event type “Z2”, and an offset “25” (corresponding to a name of a node ID “25” of FIG. 2) in the event table 150f.

At position “1024” of the BIN data 150c, no path ID included in the event definition table 150e is detected. At position “1025” of the BIN data 150c, since the path ID “6” included in the event definition table 150e is detected after the tag start symbol “[”, the event (3) occurs, and the event table creation unit 160e registers an event ID “9”, the event types “Z3 and C”, and an offset “27” (corresponding to a “cast” of a node ID “27” of FIG. 2) in the event table 150f.

At positions “1026 to 1029” of the BIN data 150c, no path ID included in the event definition table 150e is detected after the tag start symbol “[”. As described above, the event table 150f is created by the event creation table 160e comparing the positions “1001 to “1029 of the BIN data 150c with the event definition table 150e.

The event table totaling unit 160f detects a position of data (offset) corresponding to a query by totaling various types of information of the event table 150f. Then, the event table totaling unit 160f outputs the detected information to the reply transmission unit 160h.

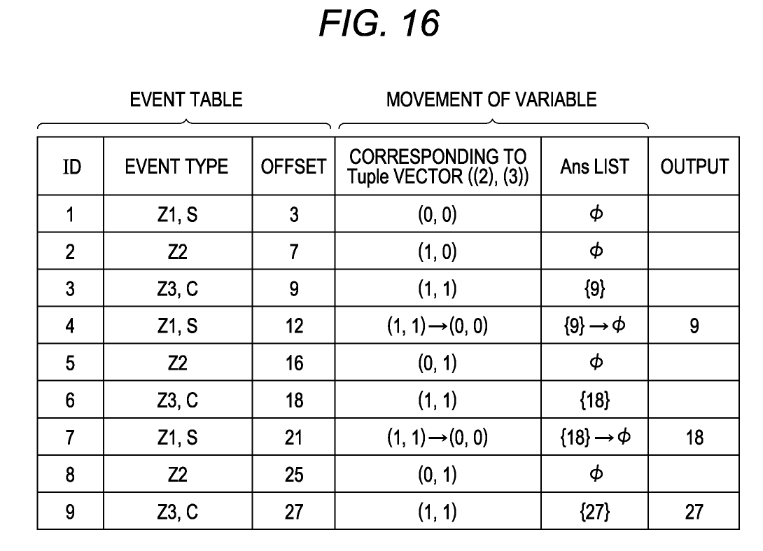

FIG. 16 is a diagram explaining processing of the event table totaling unit 160f. In FIG. 4, a bit vector (Tuple vector) is a vector for managing whether or not a given event exists.

The bit vector according to embodiment 1 manages, for example, whether or not the events (2) and (3) exist other than the query start event S. Accordingly, a two-dimensional vector composed of first and second elements is created, and when the event (2) (corresponding to Z2) exists, a bit is set to the first element. In contrast, when the event (3) (corresponding to Z3) exists, a bit is set to the second element.

In the process of totaling the event table 150f, the event table totaling unit 160f detects an event type “S”, and when the bit vector is set to (1, 1) (when it hits a check position of a query), the event table totaling unit 160f outputs a value registered to an Ans list and initializes the bit vector.

Furthermore, when the event table totaling unit 160f detects an event type “C”, it registers a value of an offset corresponding to the event to the Ans list. Note that an initial value of the Ans list is set to “φ”. In the following description, the process of the event table totaling unit 160f will be explained by using FIG. 16. The event table totaling unit 160f totals the event table 150f sequentially from the ID “1”.

The event table totaling unit 160f detects the event types “Z1” and “S” in the ID “1” of the event table 150f. However, since the bit vector is set to (0, 0), an offset of the Ans list is not output.

The event table totaling unit 160f detects the event type “Z2” in the ID “2” of the event table 150f. Accordingly, the event table totaling unit 160f sets the bit vector to (1, 0).

The event table totaling unit 160f detects the event types “Z3” and “C” in the ID “3” of the event table 150f. Accordingly, the event table totaling unit 160f sets the bit vector to (1, 1) and registers the offset “9” in the Ans list.

Since the event table totaling unit 160f detects the event types “Z1” and “S” in the ID “4” of the event table 150f and the bit vector is set to (1, 1), event table totaling unit 160f outputs the value “9” of the Ans list. Then, the event totaling unit 160f initializes the bit vector and the Ans list.

The event table totaling unit 160f detects the event type “Z2” in the ID “5” of the event table 150f. Accordingly, the event table totaling unit 160f sets the bit vector to (0, 1).

The event table totaling unit 160f detects the event types “Z3” and “C” in the ID “6” of the event table 150f. Accordingly, the event table totaling unit 160f sets the bit vector to (1, 1) and registers the offset “18” in the Ans list.

Since the event table totaling unit 160f detects the event types “Z1” and “S” in the ID “7” of the event table 150f and the bit vector is set to (1, 1), it outputs the value “18” of the Ans list. Then, the event totaling unit 160f initializes the bit vector and the Ans list.

The event table totaling unit 160f detects the event type “Z2” in the ID “8” of the event table 150f. Accordingly, the event table totaling unit 160f sets the bit vector to (0, 1).

The event table totaling unit 160f detects the event types “Z3” and “C” in the ID “9” of the event table 150f. Accordingly, the event table totaling unit 160f sets the bit vector to (1, 1) and registers the offset “27” in the Ans list.

Since an event train is ended at the ID “9”, the bit vector is checked and the Ans list is output. In the example shown in FIG. 16, since the bit vector is set to (1, 1), the event table totaling unit 160f outputs the value “27” of the Ans list. When the bit vector is set to (0, 0), (1, 0), or (0, 1), the event table totaling unit 160f does not output a value of the Ans list.

Returning to the explanation of FIG. 4, the branch query evaluation unit 160g searches for and retrieves data corresponding to a query from the XML data 150a using a method of a known technique (for example, refer to “TwigList:Make Twig Pattern Matching Fast” above)) when it is determined by the query class determination unit 160d that the query belongs to the difficult class.

That is, the branch query evaluation unit 160g scans the XML data 150a, constructs a hierarchy list for evaluating a query, scans the constructed hierarchy list structure, and determines a combination of check positions of the query in the XML data 150a so that the branch query evaluation unit 160g detects a position of a final reply and outputs a result of the detection to the reply transmission unit 160h.

The reply transmission unit 160h outputs data corresponding to a query to a terminal apparatus (terminal apparatus from which the query is transmitted). Specifically, when the reply transmission unit 160h obtains information of an offset (a check position of the query) as a result of a total from the event table totaling unit 160f, it detects data corresponding to the offset by comparing the obtained offset with the BIN data 150c and outputs a result of the detection to the terminal apparatus. Furthermore, when the reply transmission unit 160h obtains the result of the detection from the branch query evaluation unit 160g, it outputs the obtained result of the detection to the terminal apparatus.

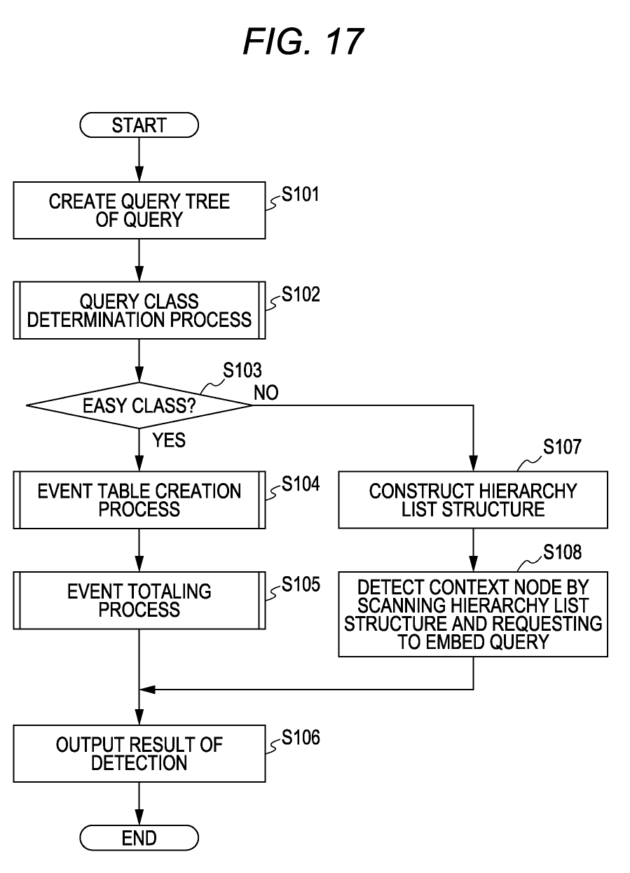

Next, a processing sequence of the search apparatus 100 according to embodiment 1 will be explained. FIG. 17 is a flowchart showing the processing sequence of the search apparatus 100 according to embodiment 1. As shown in the drawing, when the search apparatus 100 obtains information of a query from the terminal apparatus, the query tree construction unit 160c creates the query tree 150d (step S101), and the query class determination unit 160d executes a query class determination process (step S102).

When it is determined that a query belongs to the easy class (step S103, Yes), the event table creation unit 160e executes an event table creation process (step S104), the event table totaling unit 160f executes an event totaling process (step S105), and the reply transmission unit 160h outputs a result of detection to the terminal apparatus (step S106).

In contrast, when it is determined by the query class determination unit 160d that a query belongs to the difficult class (step S103, No), the branch query evaluation unit 160g constructs the hierarchy list structure (step S107), scans the hierarchy list structure, and requests to embed the query so that the query class determination unit 160d detects a context node (step S108) and goes to step S106.

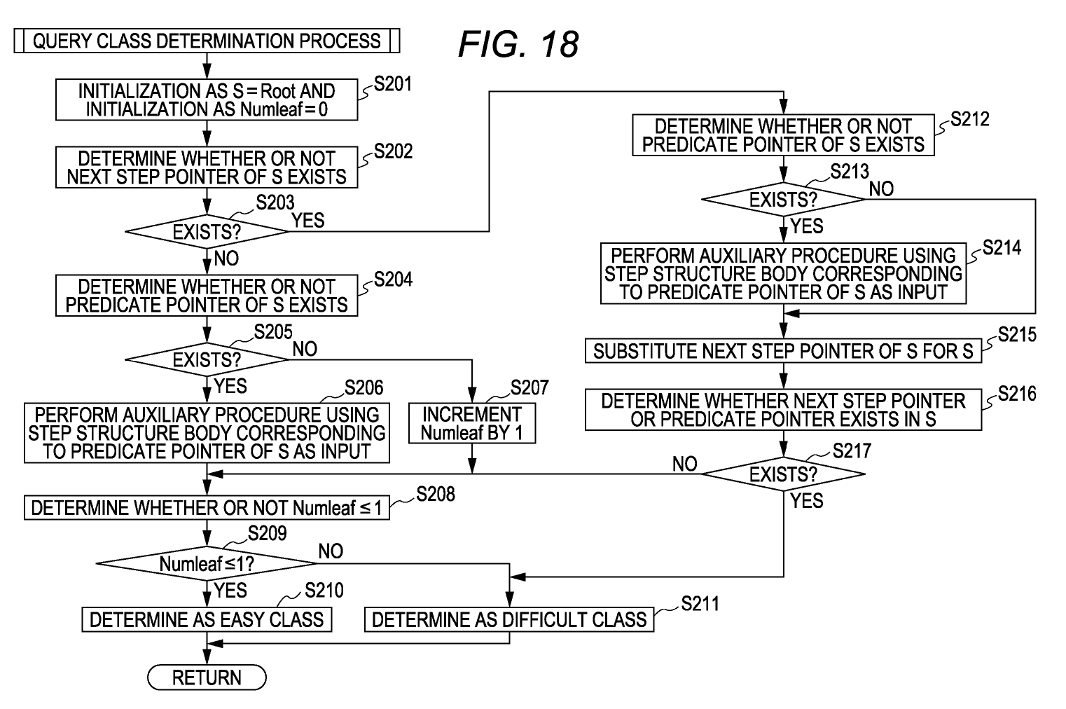

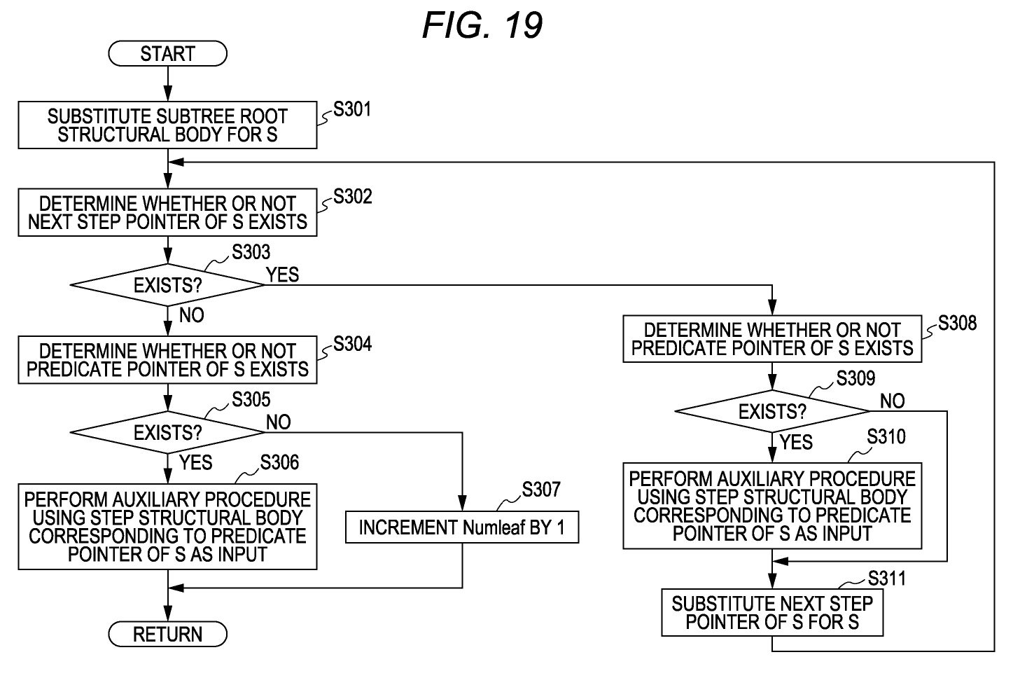

Next, the query class determination process shown at step S102 of FIG. 17 will be explained. The query class determination process has a main procedure and an auxiliary procedure. FIG. 18 is a flowchart showing the main procedure of the query class determination process, and FIG. 19 is a flowchart showing the auxiliary procedure of the query class determination process.

As shown in FIG. 18, the query class determination unit 160d executes initialization as “S=Root” and initialization as “Numleaf=0” (step S201) and determines whether or not a next step pointer of S exists (step S202). When the next step pointer does not exist (step S203, No), the query class determination unit 160d determines whether or not a predicate pointer of “S” exists (step S204).

When the predicate pointer of “S” exists (step S205, Yes), the query class determination unit 160d executes the auxiliary procedure using a step structural body corresponding to the predicate pointer of “S” as an input (step S206) and goes to step S208.

In contrast, when the predicate pointer of “S” does not exist (step S205, No), the query class determination unit 160d increments Numleaf by 1 (step S207) and determines whether or not a value of Numleaf is one or less (step S208). When the value of Numleaf is one or less (step S209, Yes), the query class determination unit 160d determines that a query belongs to the easy class (step S210). In contrast, when the value of Numleaf is larger than one (step S209, No), the query class determination unit 160d determines that the query belongs to the difficult class (step S211).

Returning to step S203, when the next step pointer of “S” exists (step S203, Yes), the query class determination unit 160d determines whether or not the predicate pointer of “S” exists (step S212), and when the predicate pointer of “S” does not exist (step S213, No), the query class determination unit 160d goes to step S215.

In contrast, when the predicate pointer of S exists (step S213, Yes), the query class determination unit 160d executes the auxiliary procedure by using the step structural body corresponding to the predicate pointer of “S” as an input (step S214) and substitutes the next step pointer of “S” for “S” (step S215).

Then, the query class determination unit 160d determines whether or not the next step pointer or the predicate pointer exists in “S” (step S216), and when it does not exist (step S217, No), the query class determination unit 160d goes to step S208. In contrast, when the next step pointer or the predicate pointer exists in “S” (step S217, Yes), the query class determination unit 160d goes to step S211.

Next, the auxiliary procedure shown at steps S206 and S214 will be explained. As shown in FIG. 19, the query class determination unit 160d substitutes a root structural body of a subtree (step structural body) for “S” (step S301) in the auxiliary procedure and determines whether or not the next step pointer of “S” exists (step S302).

When the next step pointer of “S” does not exist (step S303, No), the query class determination unit 160d determines whether or not the predicate pointer of “S” exists (step S304). When the predicate pointer of S exists (step S305, Yes), the query class determination unit 160d executes the auxiliary procedure using the step structural body to the predicate pointer of “S” as an input (step S306) and finishes the auxiliary procedure. In contrast, when the predicate pointer of “S” does not exist (step S305, No), the query class determination unit 160d increments Numleaf by 1 (step S307) and finishes the auxiliary procedure.

Returning to step S303, when the next step pointer of “S” exists (step S303, Yes), the query class determination unit 160d determines whether or not the predicate pointer of “S” exists (step S308), and when the predicate pointer of “S” does not exist (step S309, No), the query class determination unit 160d goes to step S311.

In contrast, when the predicate pointer of “S” exists (step S309, Yes), the query class determination unit 160d executes the auxiliary procedure using a step structural body corresponding to the predicate pointer of “S” as an input (step S310), substitutes the next step pointer of “S” for “S” (step S311), and goes to step S302. Note that the auxiliary procedures shown at steps S306 and S310 of FIG. 19 repeat auxiliary procedures similar to those of FIG. 19.

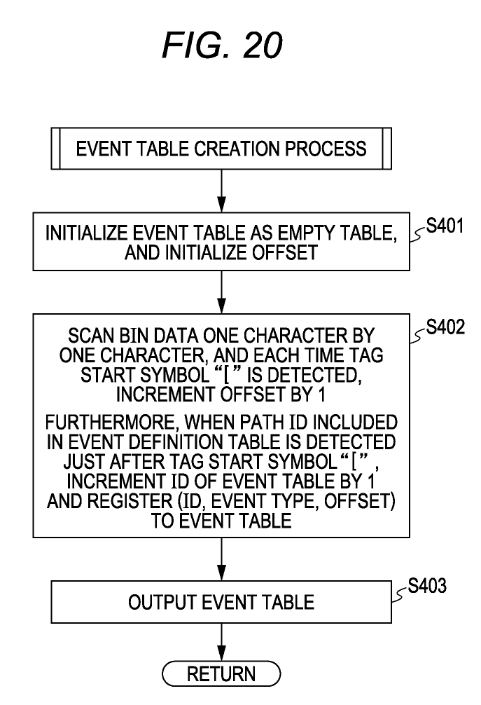

Next, a query class determination process shown at step S104 of FIG. 17 will be explained. FIG. 20 is a flowchart showing a processing sequence of the event table creation process. As shown in the diagram, the event table creation unit 160e initializes the event table 150f as an empty table and initializes an offset (step S401).

The event table creation unit 160e scans the BIN data 150c one character by one character and increments the offset by 1 each time the tag start symbol “[” is detected. Furthermore, when the event table creation unit 160e detects the path ID included in the event definition table 150e just after the tag start symbol “[”, it increments the ID of the event table by 1, registers (ID, event type, and offset) to the event table (step S402), and outputs the event table (step S403).

The event table creation unit 160e scans the BIN data 150c one character by one character and increments the offset by 1 each time the tag start symbol “[” is detected. Furthermore, when the event table creation unit 160e detects the path ID included in the event definition table 150e just after the tag start symbol “[”, it increments the ID of the event table by 1, registers (ID, event type, and offset) in the event table (step S402), and outputs the event table (step S403).

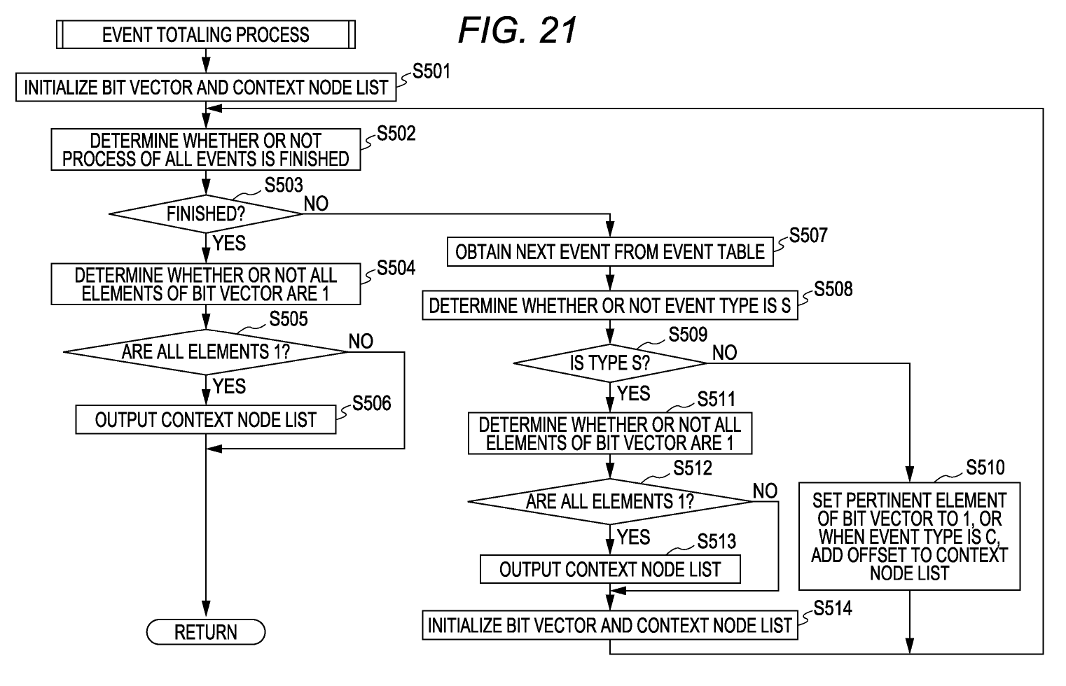

Next, the event totaling process shown at step S105 of FIG. 17 will be explained. FIG. 21 is a flowchart showing a processing sequence of the event totaling process. As shown in the diagram, the event table totaling unit 160f initializes the bit vector (Tuple vector) and the context node list (Ans list) (step S501) and determines whether or not a process of all the events is ended (step S502).

When the process of all the events is ended (step S503, Yes), the event table totaling unit 160f determines whether or not all the elements of the bit vector are 1 (step S504).When all the elements are 1 (step S505, Yes), the event table totaling unit 160f outputs the context node list (step S506) and finishes the event totaling process. In contrast, when any of the elements are not 1 (step S505, No), the event table totaling unit 160f finishes the event totaling process as is.

Returning to step S503, when the process of all the events is not ended (step S503, No), the event table totaling unit 160f obtains a next event from the event table 150f (step S507) and determines whether or not the event type is “S” (step S508).

When the event type is not “S” (step S509, No), a pertinent element of the bit vector is set to 1. Furthermore, when the event type is “C”, an offset is added to the context node list (step S510), and the event table totaling unit 160f goes to step S502.

In contrast, when the event type is “S” (step S509, Yes), whether or not all the elements of the bit vector is 1 (step S511) is determined, and when none of the elements is 1 (step S512, No), the event table totaling unit 160f goes to step S514.

In contrast, when all the elements of the bit vector are 1 (step S512, Yes), the context node list is output (step S513), the bit vector and the context node list are initialized (step S514), and the event table totaling unit 160f goes to step S502.

As described above, in the search apparatus 100 according to embodiment 1, the query class determination unit 160d determines whether or not a query belongs to the easy class or to the difficult class. When the query class determination unit 160d determines that the query belongs to the easy class, the event table creation unit 160e creates the event definition table 150e and the event table 150f, and the event table totaling unit 160f totals the event table 150f to thereby search data corresponding to the query. Accordingly, when the query belongs to the easy class, a load applied on the apparatus can be reduced and data search efficiency can be improved.

Note that since, at present, many of the actually used queries belong to the easy class to which the hierarchy management is not necessary and rarely belong to the difficult class, the search apparatus 100 according to embodiment 1 is very effective in practical use.

### Embodiment 2

Next, an application of substring matching of the search apparatus according to embodiment 1 described above will be explained as embodiment 2. A query used by the search apparatus according to the embodiment 2 includes a string. The definition “Expr::=RPath” of the query shown in embodiment 1 is expanded as described below so that it can treat substring matching: train.Expr::=RPath|contains(RPath,string)

When, for example, a query is designated as “Q3=/Syain/ACT[contains(chara/name, “red”)]/cast”, data of the element node “cast” 9 (reply B of FIG. 3) of respective nodes shown in FIG. 2 can be obtained. The query Q3 described above is a query for replying to a “cast” element (element node “cast” 9) of the element node (element node “ACT3”) whose “chara” element includes a string “red” of “/Syain/ACT” elements (element nodes “ACT3”, “12”, “21”).

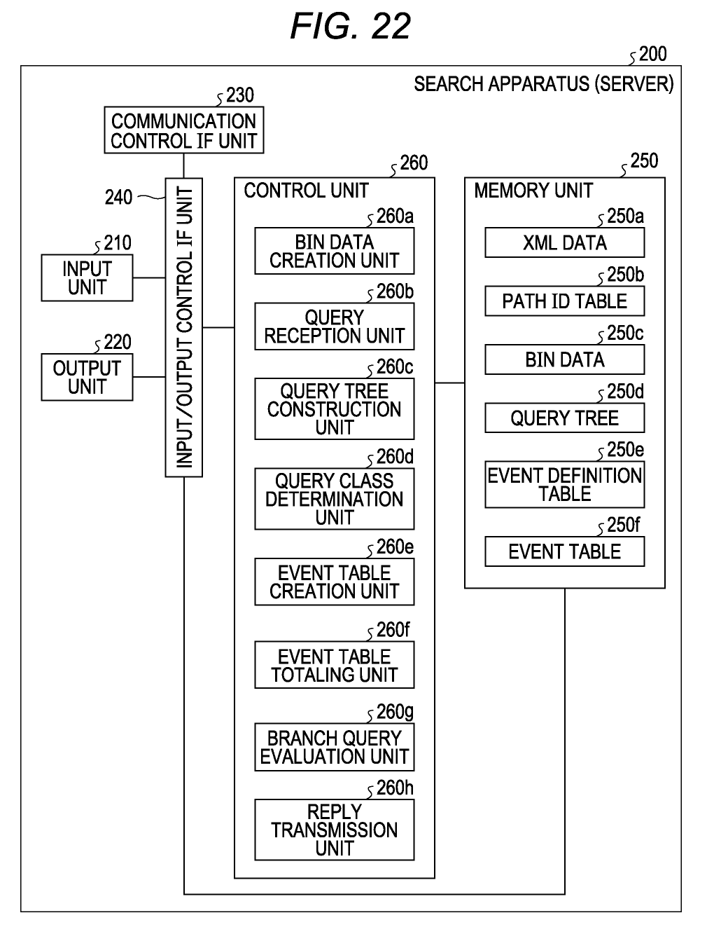

Next, a configuration of the search apparatus according to embodiment 2 will be explained. FIG. 22 is a functional block diagram showing the configuration of the search apparatus 200 according to the embodiment 2. As shown in the diagram, the search apparatus 200 has an input unit 210, an output unit 220, a communication control IF unit 230, an input/output control IF unit 240, a memory unit 250, and a control unit 260.

The input unit 210 inputs various types of information, is composed of a keyboard, a mouse, a microphone, and the like, and receives and inputs, for example, various types of information related to the XML data described above. A monitor (output unit 220) to be described below may also act as a pointing device function in cooperation with the mouse.

The output unit 220 outputs various types of information, is composed of a monitor (or a display or a touch panel), a speaker, and the like, and outputs, for example, various types of information related to the XML data described above.

The communication control IF unit 230 controls communication between terminal apparatuses. The input/output control IF unit 240 controls data input and output by the input unit 210, the output unit 220, the communication control IF unit 230, the memory unit 250, and the control unit 260.

The memory unit 250 stores data and programs for the control unit 260 to perform various processes and has XML data 250a, a path ID table 250b, BIN data 250c, a query tree 250d, an event definition table 250e, and an event table 250f as those particularly closely related to the present invention as shown in FIG. 22.

Since the XML data 250a, the path ID table 250b, the BIN data 250c, and the query tree 250d are the same as the XML data 150a, the path ID table 150b, the BIN data 150c, and the query tree 150d described in embodiment 1, the description thereof is omitted.

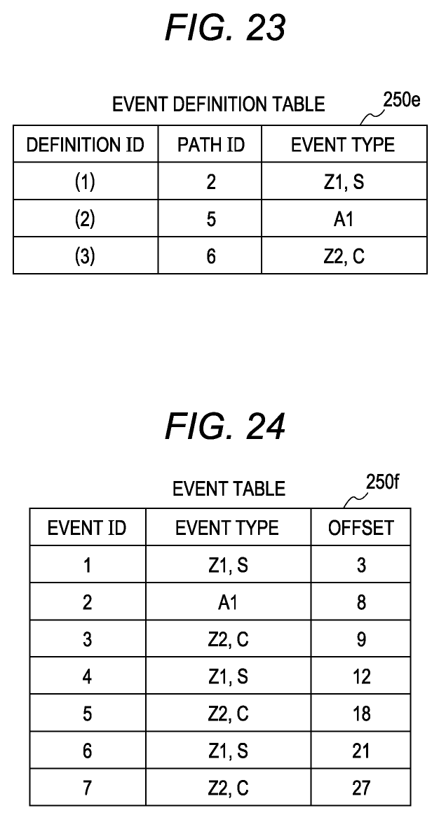

The event definition table 250e includes data in which an event type included in a query is associated with a path ID. FIG. 23 is a diagram showing an example of a data structure of the event definition table 250e according to embodiment 2. As shown in the diagram, the event definition table 250e stores a definition ID, the path ID, and the event type in association with each other. Note that the definition ID is information for identifying a combination of the path ID and the event type.

A set “ETYPE(Q)” acting as the event type has path hit events Z1 to Zn (which are associated with all the path IDs included in the query other than the path IDs in “contains”), a “path+keyword” bit events A1 to Am, a query start event S, and a context node event C. Here, the “path+keyword” bit events are events showing that a pertinent keyword is hit.

When, for example, a query is designated as “Q=/Syain/ACT[contains(chara/name, “red”)]/cast” (when shown by a path “/2[contains(5,red)]6)”, and a set of event types is designated as “ETYPE(Q)={Z1, A1, Z2}”, an event definition table shown in FIG. 23 is created.

The event table 250f includes data which substitutes the BIN data 250c for an automaton created from a query and stores, when an event occurs, information of the event (event ID, event type, and offset). FIG. 24 is a diagram showing an example of a data structure of the event definition table 250f according to embodiment 2. The event table 250f stores the event ID, the event type, and the offset in association with each other.

The control unit 260 has an internal memory for storing programs that prescribe various processing sequences, and controls data and executes various processes. The control unit 260 has a BIN data creation unit 260a, a query reception unit 260b, a query tree construction unit 260c, a query class determination unit 260d, an event table creation unit 260e, an event table totaling unit 260f, a branch query evaluation unit 260g, and a reply transmission unit 260h as those particularly closely related to the present invention as shown in FIG. 22.

Since the BIN data creation unit 260a, the query reception unit 260b, the query tree construction unit 260c, the query class determination unit 260d, the branch query evaluation unit 260g, and the reply transmission unit 260h are the same as the BIN data creation unit 160a, the query reception unit 160b, the query tree construction unit 160c, the query class determination unit 160d, the branch query evaluation unit 160g, and the reply transmission unit 160h shown in FIG. 4, the descriptions thereof are omitted.

The event table creation unit 260e obtains a result of determination from the query class determination unit 260d and, when it is determined that a query belongs to the easy class, creates the event definition table 250e (refer to FIG. 23) from the query and creates the event table 250f (refer to FIG. 24) making use of an automaton of the query.

First, a process in which the event table creation unit 260e creates the event definition table 250e will be explained. When, for example, a query is designated as “Q=/Syain/ACT[contains(chara/name, “red”)]/cast” (when shown by a path “/2[contains(5, red)]6)”, and the set of event types is designated as “ETYPE(Q)={Z1, A1, Z2}”, the event table creation unit 260e creates the event definition table 250e shown in FIG. 23 by associating a path ID and a string of the query with the set of event types.

In the above condition, the path ID “2” corresponds to the event type “Z1”, the path ID and the string “[contains(5,red)]” correspond to an event type “A1”, and the path ID “6” corresponds to the event type “Z2”. Furthermore, since the path ID “2” is a query start path, “S” is included in the event type. Since the path ID “6” is a query end path, “C” is included in the event type.

Subsequently, a process when the event table creation unit 260e creates the event table 250f will be explained. The event table creation unit 260e creates an automaton of a query as a preparation for creating the event table 250f. Note that when the event table creation unit 260e creates the automaton from the query, it is sufficient to use, for example, a method disclosed in Japanese Patent Application No. 2007-195081.

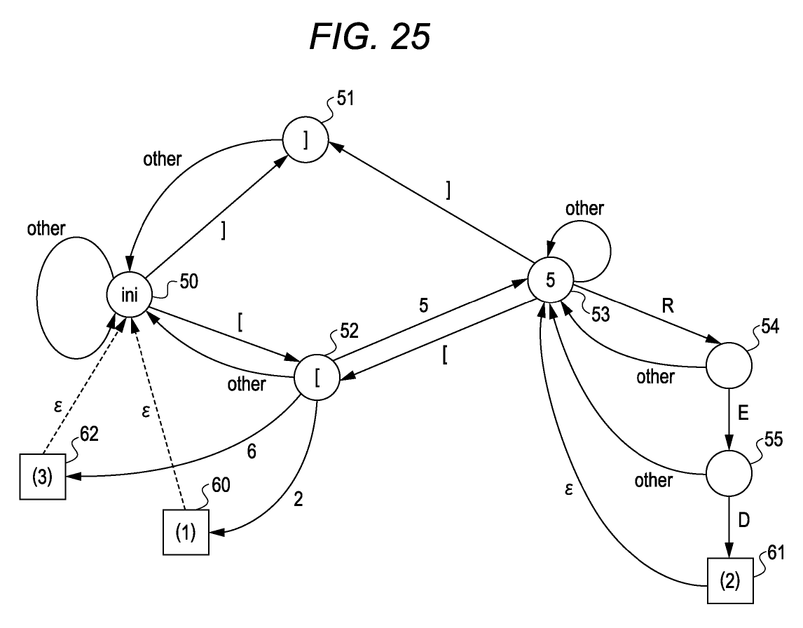

FIG. 25 is a diagram showing an example of a data structure of an automaton of a query according to embodiment 2. The automaton shown in FIG. 25 is an automaton created from a query “/Syain/ACT[contains(chara/name, “red”)]/cast” (when shown by a path “/2[contains(5, red)]6)”). The automaton has a plurality of node structural bodies 50 to 55 and a plurality of event structural bodies 60 to 62. Note that “ε” of FIG. 25 shows that a process goes in the direction of an arrow unconditionally.

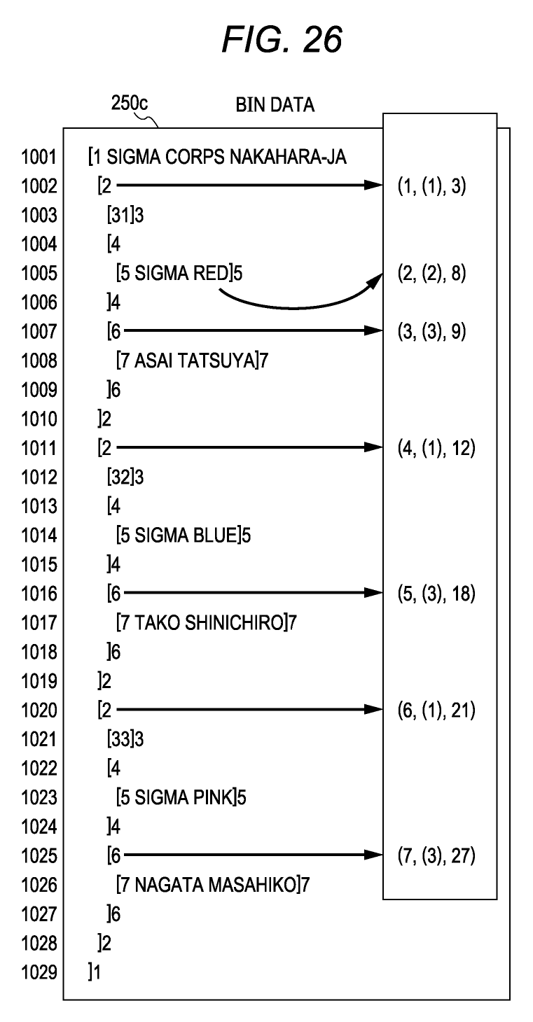

The event table creation unit 260e creates the event table 250f by sequentially substituting the BIN data 250c for the automaton shown in FIG. 25. In the following description, a process in which the event table creation unit 260e creates the event table 250f will be explained by separating the process to the positions “1001” to “1029” of the BIN data 250c of FIG. 26. FIG. 26 is a diagram explaining the process of the event table creation unit 260e according to embodiment 2. Note that the event table creation unit 260e uses the node ID of a node (refer to FIG. 2) when an event occurs as the value of the offset like embodiment 1.

The event table creation unit 260e substitutes data “[1 sigma corps nakahara-ja”, which corresponds to the position “1001” of the BIN data 250c, for an automaton. Thus, since a numeral which corresponds next does not exist at the stage the data goes to the node structure 52 using the node structure 50 as a start point, the data returns to the node structure 50, and a search of the position “1001” is ended.

The event table creation unit 260e substitutes data “[2”, which corresponds to the position “1002” of the BIN data 250c, for the automaton. Thus, the data reaches an event structure 60 using the node structure 50 as a start point. At the time the data reaches the event structure 60, an event (1) (event definition ID (1)) occurs, and the event table creation unit 260e registers the event ID “1”, the event types “Z1, S”, and an offset “3” to the event table 250f. Note that the event type is specified by comparing the event definition ID with the event definition table 250e (refer to FIG. 23).

The event table creation unit 260e substitutes data “[31]3”, which corresponds to the position “1003” of the BIN data 250c, for the automaton. Thus, since a numeral which corresponds next does not exist at the stage the data goes to the node structure 52 using the node structure 50 as a start point, the data returns to the node structure 50, and a search of the position “1003” is ended.

The event table creation unit 260e substitutes data “[4”, which corresponds to the position “1004” of the BIN data 250c, for the automaton. Thus, since a numeral which corresponds next does not exist at the stage the data goes to the node structure 52 using the node structure 50 as a start point, the data returns to the node structure 50, and a search of the position “1004” is ended.

The event table creation unit 260e substitutes data “[5 sigma red]5”, which corresponds to the position “1005” of the BIN data 250c, for the automaton. Thus, the data reaches an event structure 61 using the node structure 50 as a start point. At the time the data reaches the event structure 61, an event (2) occurs, and the event table creation unit 260e registers the event ID “2”, the event type “A1”, and an offset “8” to the event table 250f.

The event table creation unit 260e substitutes data “]4”, which corresponds to the position “1006” of the BIN data 250c, for the automaton. Thus, the data returns to the node structural body 50 at the stage the data moves to the node structural body 51 using the node structural body 50 as a start point, and a search of the position “1006” is ended.

The event table creation unit 260e substitutes data “[6”, which corresponds to the position “1007” of the BIN data 250c, for the automaton. Thus, the data reaches an event structural body 62 using the node structural body 50 as a start point. At the time the data reaches the event structural body 62, an event (3) occurs, and the event table creation unit 260e registers the event ID “3”, the event types “Z2, C”, and an offset “9” to the event table 250f.

The event table creation unit 260e substitutes data “[7 asai tatsuya]7”, which corresponds to the position “1008” of the BIN data 250c, for the automaton. Thus, since a numeral which corresponds next does not exist at the stage the data goes to the node structure 52 using the node structure 50 as a start point, the data returns to the node structure 50, and a search of the position “1008” is ended.

The event table creation unit 260e substitutes data “]6”, which corresponds to the position “1009” of the BIN data 250c, for the automaton. Thus, the data returns to the node structural body 50 at the stage it moves to the node structural body 51 using the node structural body 50 as a start point, and a search of the position “1009” is ended.

The event table creation unit 260e substitutes data “]2”, which corresponds to the position “1010” of the BIN data 250c, for the automaton. Thus, the data returns to the node structural body 50 at the stage it moves to the node structural body 51 using the node structural body 50 as a start point, and a search of the position “1010” is ended.

The event table creation unit 260e substitutes data “[2”, which corresponds to the position “1011” of the BIN data 250c, for the automaton. Thus, the data reaches the event structural body 60 using the node structural body 50 as a start point. At the time the data reaches the event structural body 60, the event (1) occurs, and the event table creation unit 260e registers an event ID “4”, the event types “Z1, S”, and an offset “12” to the event table 250f.

The event table creation unit 260e substitutes data “[32]3”, which corresponds to the position “1012” of the BIN data 250c, for the automaton. Thus, since a numeral which corresponds next does not exist at the stage the data goes to the node structural body 52 using the node structural body 50 as a start point, it returns to the node structural body 50, and a search of the position “1012” is ended.

The event table creation unit 260e substitutes data “[4”, which corresponds to the position “1013” of the BIN data 250c, for the automaton. Thus, since a numeral which corresponds next does not exist at the stage the data goes to the node structural body 52 using the node structural body 50 as a start point, it returns to the node structural body 50, and a search of the position “1013” is ended.

The event table creation unit 260e substitutes data “[5 sigmablue]5”, which corresponds to the position “1014” of the BIN data 250c, for the automaton. Thus, since a numeral which corresponds next does not exist at the stage the data goes to the node structural body 52 using the node structural body 50 as a start point, the data returns to the node structural body 50, and a search of the position “1014” is ended.

The event table creation unit 260e substitutes data “]4”, which corresponds to the position “1015” of the BIN data 250c, for the automaton. Thus, the data returns to the node structural body 50 at the stage the data moves to the node structural body 51 using the node structural body 50 as a start point, and a search of the position “1015” is ended.

The event table creation unit 260e substitutes data “[6”, which corresponds to the position “1016” of the BIN data 250c, for the automaton. Thus, the data reaches the event structural body 62 using the node structural body 50 as a start point. At the time the data reaches the event structural body 62, the event (3) occurs, and the event table creation unit 260e registers an event ID “5”, the event types “Z2, C”, and an offset “18” to the event table 250f.

The event table creation unit 260e substitutes data “[7 tako shinichirou]7”, which corresponds to the position “1017” of the BIN data 250c, for the automaton. Thus, since a numeral which corresponds next does not exist at the stage the data goes to the node structural body 52 using the node structural body 50 as a start point, the data returns to the node structural body 50, and a search of the position “1017” is ended.

The event table creation unit 260e substitutes data “]6”, which corresponds to the position “1018” of the BIN data 250c, for the automaton. Thus, the data returns to the node structural body 50 at the stage the data moves to the node structural body 51 using the node structural body 50 as a start point, and a search of the position “1018” is ended.

The event table creation unit 260e substitutes data “]2”, which corresponds to the position “1019” of the BIN data 250c, for the automaton. Thus, the data returns to the node structural body 50 at the stage the data moves to the node structural body 51 using the node structural body 50 as a start point, and a search of the position “1019” is ended.

The event table creation unit 260e substitutes data “[2”, which corresponds to the position “1020” of the BIN data 250c, for the automaton. Thus, the data reaches the event structural body 60 using the node structural body 50 as a start point. At the time the data reaches the event structural body 60, the event (1) occurs, and the event table creation unit 260e registers the event ID “6”, the event types “Z1, S”, and an offset “21” to the event table 250f.

The event table creation unit 260e substitutes data “[33]3”, which corresponds to the position “1021” of the BIN data 250c, for the automaton. Thus, since a numeral which corresponds next does not exist at the stage the data goes to the node structural body 52 using the node structural body 50 as a start point, the data returns to the node structural body 50, and a search of the position “1021” is ended.

The event table creation unit 260e substitutes data “[4”, which corresponds to the position “1022” of the BIN data 250c, for the automaton. Thus, since a numeral which corresponds next does not exist at the stage the data goes to the node structural body 52 using the node structural body 50 as a start point, the data returns to the node structural body 50, and a search of the position “1022” is ended.

The event table creation unit 260e substitutes data “[5 sigmapink]5”, which corresponds to the position “1023” of the BIN data 250c, for the automaton. Thus, since a numeral which corresponds next does not exist at the stage the data goes to the node structural body 52 using the node structural body 50 as a start point, the data returns to the node structural body 50 and a search of the position “1023” is ended.

The event table creation unit 260e substitutes data “]4”, which corresponds to the position “1024” of the BIN data 250c, for the automaton. Thus, the data returns to the node structural body 50 at the stage the data moves to the node structural body 51 using the node structural body 50 as a start point, and a search of the position “1024” is ended.

The event table creation unit 260e substitutes data “[6”, which corresponds to the position “1025” of the BIN data 250c, for the automaton. Thus, the data reaches the event structural body 62 using the node structural body 50 as a start point. At the time the data reaches the event structural body 62, the event (3) occurs, and the event table creation unit 260e registers an event ID “7”, the event types “Z2, C”, and an offset “27” to the event table 250f.

Note that no event occurs at the positions “1026” to “1029” of the BIN data 250c. As described above, the event table creation unit 260e creates the event table 250f by substituting data of the positions “1001” to “1029” of the BIN data 250c for the automaton.

The event table totaling unit 260f detects a position of data (offset) corresponding to a query by totaling various types of information of the event table 250f. Then, the event table totaling unit 260f outputs the detected information to the reply transmission unit 260h.

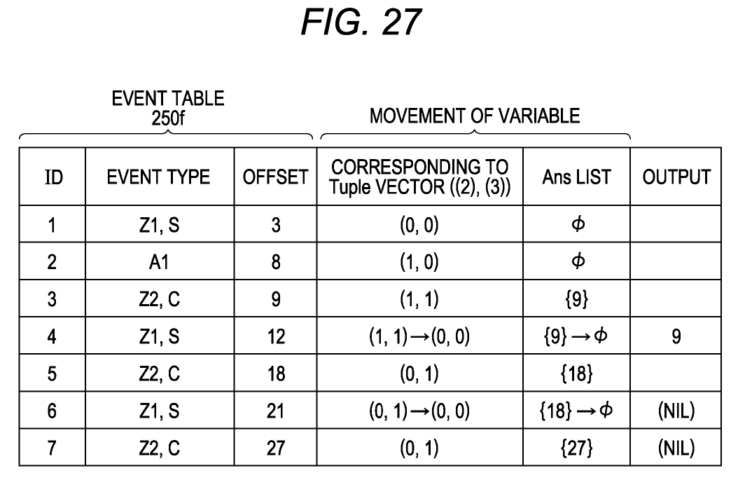

FIG. 27 is a diagram explaining a process of the event table creation unit 260f according to embodiment 2. In FIG. 27, a bit vector (Tuple vector) is a vector for managing whether or not a given event exists.

The bit vector according to embodiment 2 manages, for example, whether or not the events (2) and (3) other than the query start event “S” exist. Accordingly, the bit vector is arranged as a two-dimensional vector composed of first and second elements, and when the event (2) (corresponding to A1) exists, a bit is set to the first element. In contrast, when the event (3) (corresponding to Z2) exists, a bit is set to the second element.

In the process in which the event table totaling unit 260f totals the event table 250f, the event table totaling unit 260f detects the event type “S”, and when the bit vector is set to (1, 1) (when the check position of a query is hit), the event table totaling unit 260f outputs a value registered in an Ans list and initializes the bit vector.

Furthermore, when the event table totaling unit 260f detects the event type “C”, the event table totaling unit 260f registers a value of an offset corresponding to the event in the Ans list. Note that an initial value of the Ans list is set to “φ”. In the following description, the process of the event table totaling unit 260f will be explained by using FIG. 27. The event table totaling unit 260f totals the event table 250f sequentially from the ID “1”.

The event table totaling unit 260f detects the event types “Z1” and “S” in the ID “1” of the event table 250f. However, since the bit vector is set to (0, 0), the event table totaling unit 260f does not output the Ans list.

The event table totaling unit 260f detects the event type “A1” in the ID “2” of the event table 250f. Accordingly, the event table totaling unit 260f sets the bit vector to (1, 0).

The event table totaling unit 260f detects the event types “Z2” and “C” in the ID “3” of the event table 250f. Accordingly, the event table totaling unit 260f sets the bit vector to (1, 1) and registers the offset “9” in the Ans list.

Since the event table totaling unit 260f detects the event types “Z1” and “S” in the ID “4” of the event table 250f and the bit vector is set to (1, 1), the event table totaling unit 260f outputs the value “9” of the Ans list. Then, the event totaling unit 260f initializes the bit vector and the Ans list.

The event table totaling unit 260f detects the event types “Z2” and “C” in the ID “5” of the event table 250f. Accordingly, the event table totaling unit 260f sets the bit vector to (0, 1) and registers the offset “18” in the Ans list.

The event table totaling unit 260f detects the event types “Z1” and “S” in the ID “6” of the event table 250f. However, since the bit vector is set to (0, 1), the event table totaling unit 260f initializes the Ans list and the bit vector without outputting an offset of the Ans list.

The event table totaling unit 260f detects the event types “Z2” and “C” in the ID “7” of the event table 250f. Accordingly, the event table totaling unit 260f sets the bit vector to (0, 1) and registers the offset “27” in the Ans list.

Note that since an event train is ended in the ID “7”, the bit vector is checked, and the Ans list is output. In an example shown in FIG. 27, since the bit vector is set to (0, 1), the event table totaling unit 260f does not output the value of the Ans list.

As described above, in the search apparatus 200 according to embodiment 2, the query class determination unit 260d determines whether or not a query belongs to the easy class or to the difficult class. When the query class determination unit 260d determines that the query belongs to the easy class, the event table creation unit 260e creates an automaton of the query and creates the event table 250f by substituting the BIN data 250c for the automaton. Since data corresponding to the query is searched when the event table totaling unit 260f totals the event table 250f, when the query belongs to the easy class, a load applied to the apparatus can be reduced and data search efficiency can be improved even if a string is included in the query.

### Embodiment 3

Next, an application of a logical expression of the search apparatus according to the embodiment 1 described above will be explained as embodiment 3. A query used by a search apparatus according to the embodiment 3 includes a logical expression. The definition “Pred::=Expr” of a query shown in embodiment 1 is expanded as described below so that it can treat the logical expression:

Pred::=Expr|Expr “and” Expr|Expr” or “Expr|“not”ExprStep::=Axis“::”Ntest(“[“Pred”]”)*

Here, “*” in the Step row denotes zero or more repetitions. Note that two or more repetitions of “Pred” have the same meaning as “and”. For example, a query “/A[B][C]” and a query “/A[B and C]” have the same meaning.

When, for example, a query is designated as “Q4=/Syain/ACT[contains(chara/name,red) or cast]/id”, data of the element nodes id 4, 13, 22, which satisfy a logic condition, of respective nodes shown in FIG. 2 (reply G, reply H, reply I of FIG. 3) can be obtained. The query Q4 is a query for replying to “id” elements (element node id 4, 13, 22) of the element node (element node ACT3), in which a “chara” element of the element node includes a string “red”, or to the element nodes (element node ACT 3, 12, 21), in which the “chara” element of the element node includes a element node “cast” in the “/Syain/ACT” elements (elements nodes ACT 3, 12, 21).

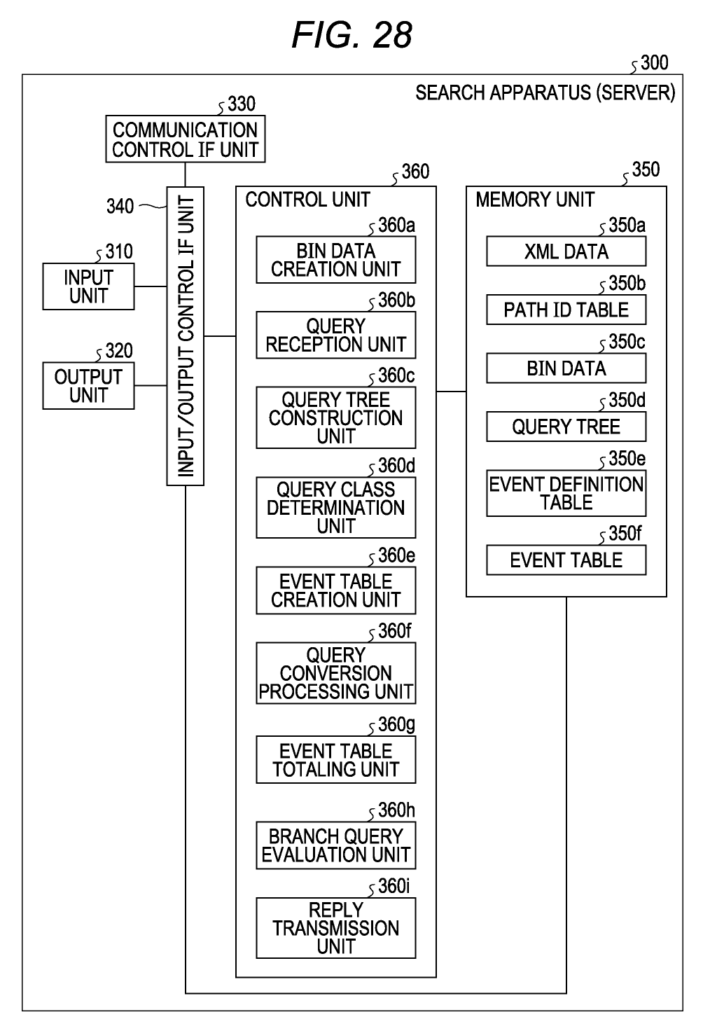

Next, a configuration of the search apparatus according to embodiment 3 will be explained. FIG. 28 is a functional block diagram showing a configuration of the search apparatus according to embodiment 3. As shown in the drawing, the search apparatus 300 has an input unit 310, an output unit 320, a communication control IF unit 330, an input/output control IF unit 340, a memory unit 350, and a control unit 360.

The input unit 310 inputs various types of information, is composed of a keyboard, a mouse, a microphone, and the like, and receives and inputs, for example, various types of information related to the XML data described above. Note that the monitor described below (output unit 320) may also act as a pointing device function in cooperation with the mouse.

The output unit 320 outputs various types of information, is composed of a monitor (or a display, a touch panel), a speaker, and the like, and outputs, for example, various types of information related to the XML data described above.

The communication control IF unit 330 controls communication between terminal apparatuses. The input/output control IF unit 340 controls the data input and output executed by the input unit 310, the output unit 320, the communication control IF unit 330, the memory unit 350, and the control unit 360.

The memory unit 350 stores data and programs for the control unit 360 to perform various processes, and has XML data 350a, a path ID table 350b, BIN data 350c, a query tree 350d, an event definition table 350e, and an event table 350f as those particularly closely related to the present invention as shown in FIG. 28.

Since the XML data 350a, the path ID table 350b, and the BIN data 350c are the same as the XML data 150a, the path ID table 150b, and the BIN data 150c shown in embodiment 1, the descriptions thereof are omitted.

The query tree 350d is data for storing a query tree constructed from a query, and the query tree is composed of a plurality of step structural bodies. Here, a step is shown by a trinomial set of an axis, a tag name, and a predicate (in embodiment 3, only a child axis is treated as the axis).

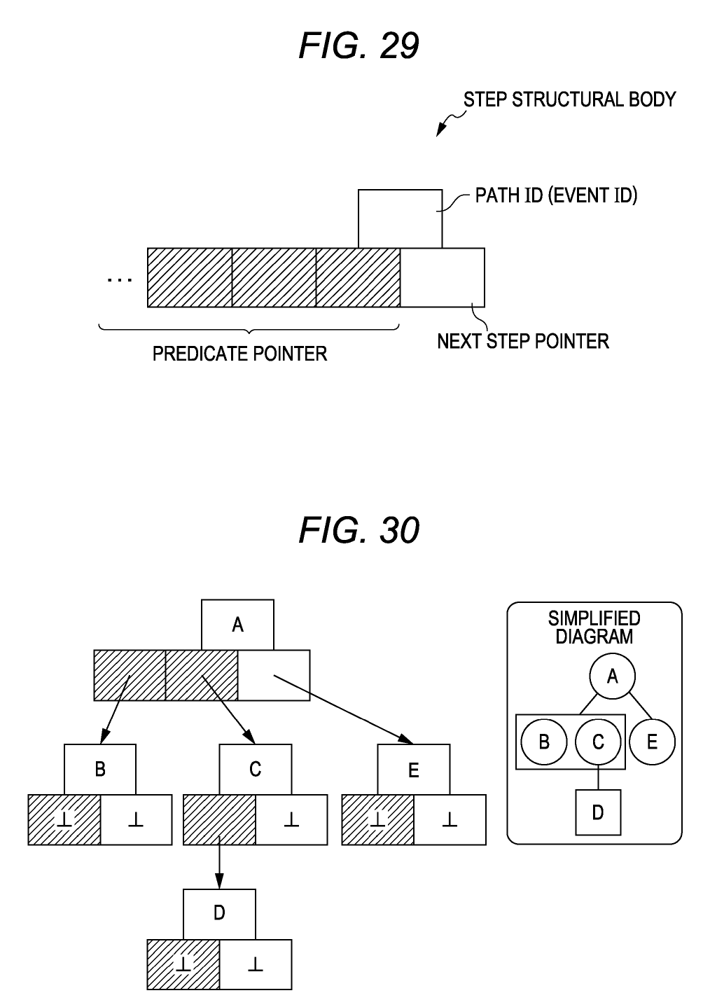

FIG. 29 is a diagram explaining a data structure of the step structural body according to embodiment 3. As shown in the drawing, the step structural body has a path ID (event ID), a plurality of predicate pointers (when a logical expression is included in a query, the step structural body has a plurality of predicate pointers), and a next step pointer. The predicate pointer is a pointer of a step structural body showing a predicate, and the next step pointer is a pointer of a step structural body acting as a next step. Note that a step structural body that acts as a root of a query tree is shown as “Root”, and a step structural body shown by a next step structural body of “Root” is shown as a “second step” of the query tree.

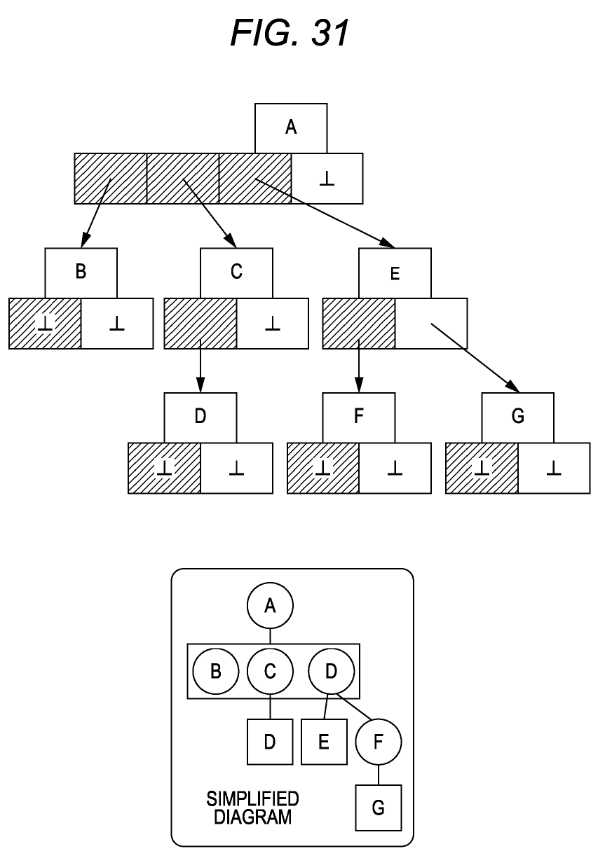

Here, an example of a query tree to a query will be shown. FIGS. 30 and 31 are diagrams showing examples of query trees according to embodiment 3. The query tree of FIG. 30 shows a query tree of a query “/A[B or C[D]]E”.

As shown in FIG. 30, the query tree is composed of step structural bodies of path ID “A, B, C, D, E”. A predicate pointer of the step structural body of the path ID “A” is connected to the step structural bodies of the path ID “A, B”, and a predicate pointer of the step structural body of the path ID “C” is connected to the step structural body of the path ID “C”. Furthermore, a next step pointer of the step structural body of the path ID “A” is connected to the step structural body of the path ID “E”.

The predicate pointers and the next step pointers of the step structural bodies of the path ID “B, D, E” are set to “Null” (⊥), and the next step pointer of the step structural body of the path ID “C” is set to “Null” (⊥). In FIG. 30, the step structural body of the path ID “A” acts as “Root”, and the step structural body of the path ID “E” acts as the “second step”. Note that a diagram on the right side of FIG. 30 is a simplified diagram of the query tree shown on the left side of FIG. 30.

The query tree of FIG. 31 shows a query tree of a query “/A[B and C[D] or E[F]G]”. As shown in the drawing, the query tree is composed of step structural bodies of the path ID “A, B, C, D, E”, and path ID “F, G”. A predicate pointer of the step structural body of the path ID “A” is connected to the step structural bodies of the path ID “B, C, E”.

Furthermore, a predicate pointer of the step structural body of the path ID “C” is connected to the step structural body of the path ID “D”. A predicate pointer of the step structural body of the path ID “E” is connected to the step structural body of the path ID “F”. Furthermore, a next step pointer of the step structural body of the path ID “E” is connected to the step structural body of the path ID “G”.

The predicate pointers and the next step pointers of the step structural bodies of the path ID “B, D, F, G” are set to “Null” (⊥), and the next step pointers of the step structural bodies of the path ID “A, C” are set to “Null” (⊥). In FIG. 31, the step structural body of the path ID “A” acts as “Root”, and a step structural body of the second step does not exist. Note that the diagram at the bottom of FIG. 31 is a simplified diagram of the query tree shown at the top of FIG. 31.

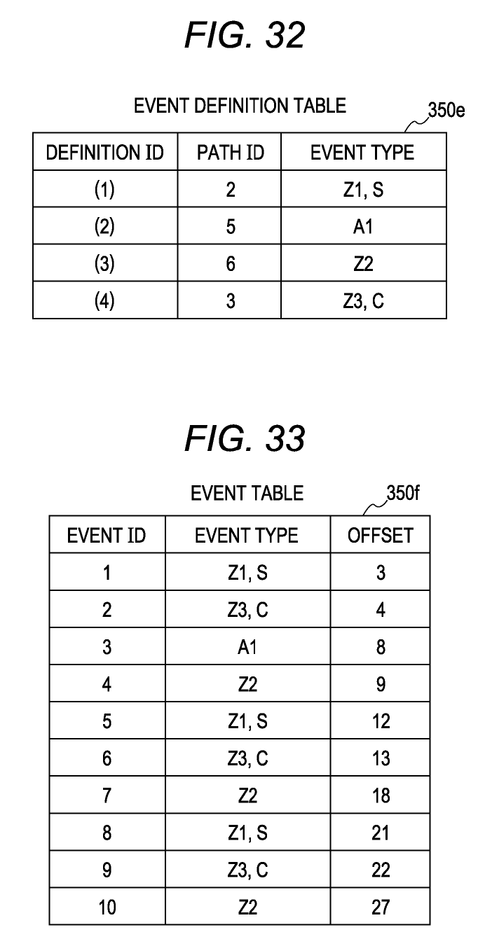

The event definition table 350e includes data in which an event type included in a query is associated with the path ID. FIG. 32 is a diagram showing an example of a data structure of the event definition table 350e according to embodiment 3. As shown in the drawing, the event definition table 350e stores a definition ID, the path ID, and the event type in association with each other. Note that the definition ID is information for identifying a combination of the path ID and the event type.

A set “ETYPE (Q)” acting as the event type has path hit events Z1 to Zn (which are associated with all the path IDs other than the path IDs in “contains” of the path IDs included in queries), a “path+keyword” bit events A1 to Am, a query start event “S”, and a context node event “C”. Here, the “path+the keyword” bit events are events showing that a pertinent keyword is hit.

When, for example, a query is designated as “Q=/Syain/ACT[contains(chara/name, “red”) or cast]/id” (when shown by a path “/2[contains(5,red) or 6]3)”, and a set of event types is designated as “ETYPE(Q)={Z1, A1, Z2, Z3}”, an event definition table shown in FIG. 32 is created.

The event table 350f includes data that substitutes the BIN data 350c for an automaton created from a query, and stores information of the event (event ID, event type, and offset) when an event occurs. FIG. 33 is a diagram showing an example of a data structure of the event definition table 350f according to embodiment 3. As shown in the drawing, the event table 350f stores the event ID, the event type, and the offset in association with each other.

The control unit 360 has an internal memory for storing programs, which prescribe various processing sequences, and controls data, and executes various processes. The control unit 360 has a BIN data creation unit 360a, a query reception unit 360b, a query tree construction unit 360c, a query class determination unit 360d, an event table creation unit 360e, a query conversion processing unit 360f, an event table totaling unit 360g, a branch query evaluation unit 360h, and a reply transmission unit 360i as those particularly closely related to the present invention as shown in FIG. 28.

Since the BIN data creation unit 360a, the query reception unit 360b, the branch query evaluation unit 360h, and the reply transmission unit 360i are the same as the BIN data creation unit 160a, the query reception unit 160b, the branch query evaluation unit 160g, and the reply transmission unit 160h shown in FIG. 4, the descriptions thereof are omitted.

The query tree construction unit 360c constructs the query tree 350d (refer to FIGS. 30, 31) based on a query.

The query class determination unit 360d determines whether or not a query belongs to an easy class or a difficult class based on a query tree. When a query belongs to the easy class, the search apparatus 300 searches data corresponding to the query without executing a hierarchy management. In contrast, when a query belongs to the difficult class, the search apparatus 300 searches data corresponding to the query by executing the hierarchy management like a conventional apparatus.

Specifically, the query class determination unit 360d first detects the number of leaves of a query tree. The query class determination unit 160d defines the number of leaves Numleaf (S) by dividing an arbitrary subtree (step structural body) S of the query tree into “a subtree S with only leaves” and “a subtree S without leaves” as defined below.

(Number of Leaves of Subtree S with Only leaves; leaf condition 1) The subtree S with only leaves (a next step pointer and a predicate pointer of the subtree S are set to Null) is defined as “NumLeaf (S)=1”.

(Number of Leaves of Subtree S that is not a leaf; leaf condition 2) Subtrees of S are set to N. P1 to Pm (m≧0) for the subtree S that is not a leaf. Here, the subtree N is a subtree that uses a next step pointer of the subtree S as a root, and the subtrees P1 to Pm are subtrees that use a predicate pointer of the subtree S as a root. The number of leaves NumLeaf(S) of the subtree S is defined according to the conditions described below.

Specifically, when the subtree S has at least one next step pointer and no predicate pointer (leaf condition 2-1), the number of leaves NumLeaf(S) becomes “NumLeaf(S)=NumLeaf(N)”.

Furthermore, when the subtree S has at least one predicate pointer and no next step pointer (leaf condition 2-2), the number of leaves NumLeaf(S) becomes “NumLeaf(S)=Max{NumLeaf(P1) to NumLeaf(Pm)}=Max{NumLeaf(P1) to NumLeaf(Pm)}”.

Furthermore, when the subtree S has a next step pointer as well as at least one predicate pointer (leaf condition 2-3), the number of leaves NumLeaf(S) becomes “NumLeaf(S)=NumLeaf(N)+Max{NumLeaf(P1) to NumLeaf(Pm)}”.

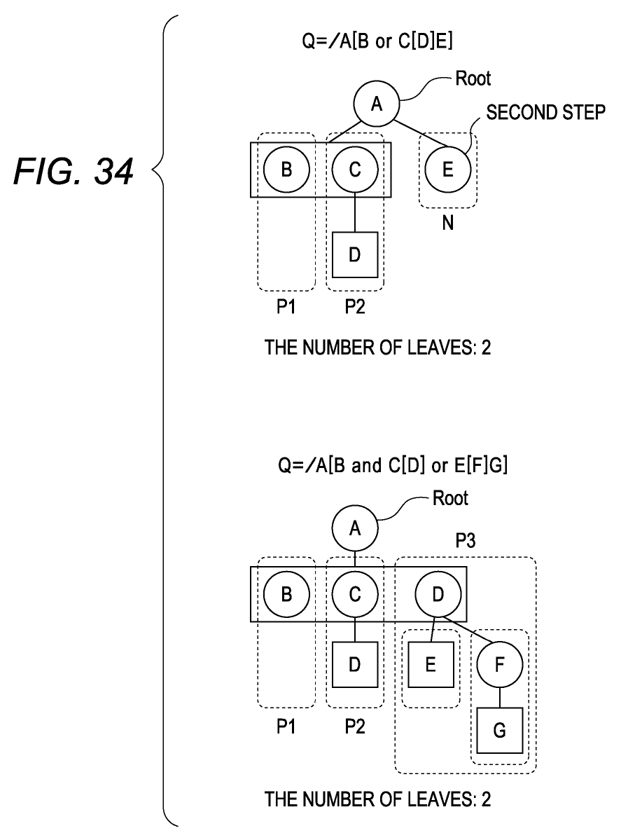

Next, a specific example of the number of leaves of a subtree will be explained. FIG. 34 is a diagram explaining the number of leaves of the subtree. The diagram at the top of FIG. 34 shows a subtree (query tree) of a query “/A[B or C[D]E”, and the diagram at the bottom of FIG. 34 shows a subtree (query tree) of a query “/A[B and C[D] or E[F]G]”.

First, the number of leaves of a subtree of the query “/A[B or C[D]E” will be explained. As shown at the top of FIG. 34, since the subtree of the query corresponds to the leaf condition 2-3, the number of leaves “NumLeaf(Q)” of the subtree “Q” is shown by “NumLeaf(Q)=NumLeaf(N)+Max{NumLeaf(P1), NumLeaf(P2)}”. “NumLeaf(N)” is the number of leaves “1” of the subtree “N”, “NumLeaf(P1)” is the number of leaves “1” of the subtree “P1”, and “NumLeaf(P2)” is the number of leaves “1” of the subtree “P2”. As a result, the number of leaves “NumLeaf(Q)” of the subtree “Q” is shown by “NumLeaf(Q)=1+Max{1, 1}=2”.

Next, the number of leaves of a subtree of the query “/A[B and C[D] or E[F]G]” will be explained. As shown at the bottom of FIG. 34, since the subtree of the query corresponds to the leaf condition 2-2, the number of leaves “NumLeaf(Q)” of the subtree “Q” is shown by “NumLeaf(Q)=Max{NumLeaf(P1), NumLeaf(P2), NumLeaf(P3)}”. “NumLeaf(P1)” is the number of leaves “1” of the subtree “P1”, “NumLeaf(P2)” is the number of leaves “1” of the subtree “P2”, and “NumLeaf(P3)” is the number of leaves “2” of the subtree “P3”. As a result, the number of leaves “NumLeaf(Q)” of the subtree Q is shown by “NumLeaf(Q)=Max{1, 1, 2}=2”.

Subsequently, the query class determination unit 360d determines a query class based on a first condition and a second condition. Here, the first condition is “the number of leaves of a query is one”, and the second condition is “the number of leaves of a query is two, the second step exists, and the predicate pointer and the next step pointer of the second step are both Null”.

When a query is established by any one of the first condition and the second condition, the query class determination unit 360d determines that the query belongs to the easy class. In contrast, when the query is not established by the first condition or the second condition, the query class determination unit 360d determines that a query belongs to the difficult class.

The query class determination unit 360d will be explained here using FIG. 34. Since the query tree at the top of FIG. 34 has the number of leaves “2” and the predicate pointer and the next step pointer of the second step are both Null, the second condition is established. Accordingly, the query class determination unit 360d determines that the query “/A[B and C[D]E” belongs to the easy class.

Furthermore, the query tree at the bottom of FIG. 34 has the number of leaves of “2”. However, since the second step does not exist, neither the first condition nor the second condition is established. Accordingly, the query class determination unit 360d determines that the query “/A[B and C[D] or E[F]G]” belongs to the difficult class.

Returning to FIG. 28, the event table creation unit 360e obtains a result of determination from the query class determination unit 360d and, when it is determined that a query belongs to the easy class, creates the event definition table 350e (refer to FIG. 32) from the query and creates the event table 350f (refer to FIG. 33) making use of an automaton of the query.

First, a process in which the event table creation unit 360e creates the event definition table 350e will be explained. When, for example, a query is designated as “Q=/Syain/ACT[contains(chara/name, “red”) or cast]/id” (when shown by a path: “/2[contains(5, red) or 6]3)”, and a set of event types is designated as “ETYPE(Q)={Z1, A1, Z2, Z3}”, the event table creation unit 360e creates the event definition table 350e shown in FIG. 32 by associating a path ID and a string of the query with the set of event types.

In the above condition, a path ID “2” corresponds to the event type “Z1”, the path ID and a string “[contains (5,red)]” correspond to the event type “A1”, a path ID “6” corresponds to the event type “Z2”, and a path ID “3” corresponds to the event type “Z3”. Furthermore, since the path ID “2” is a query start path, “S” is included in the event type. Since the path ID “3” is a query end path, “C” is included in the event type.

Subsequently, a process when the event table creation unit 360e creates the event table 350f will be explained. The event table creation unit 360e creates an automaton of a query as a preparation for creating the event table 350f.

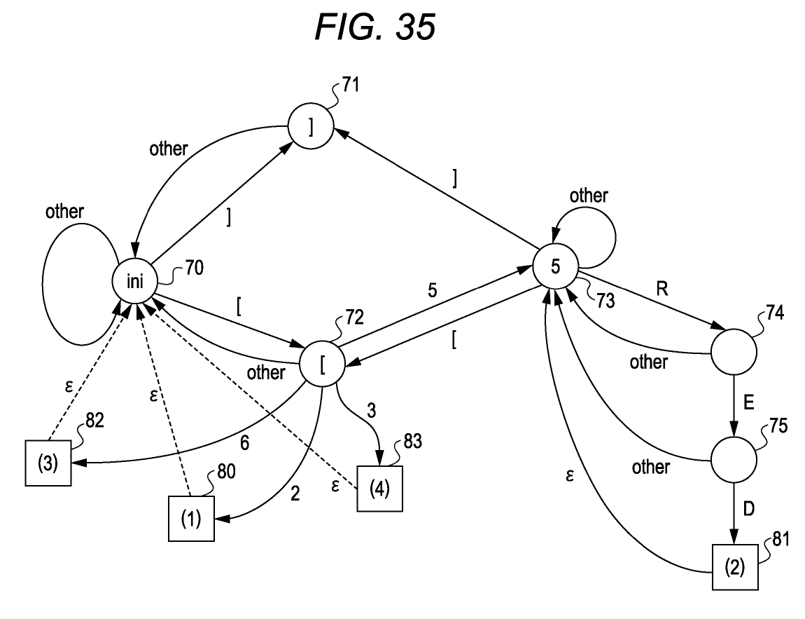

FIG. 35 is a diagram showing an example of a data structure of an automaton of a query according to embodiment 3. The automaton shown in FIG. 35 is an automaton created from the query: “/Syain/ACT[contains(chara/name, “red”) or cast]/id” (when shown by a path: “/2[contains(5, red) or 6]3)”. The automaton has a plurality of node structures 70 to 75 and a plurality of event structures 80 to 83.

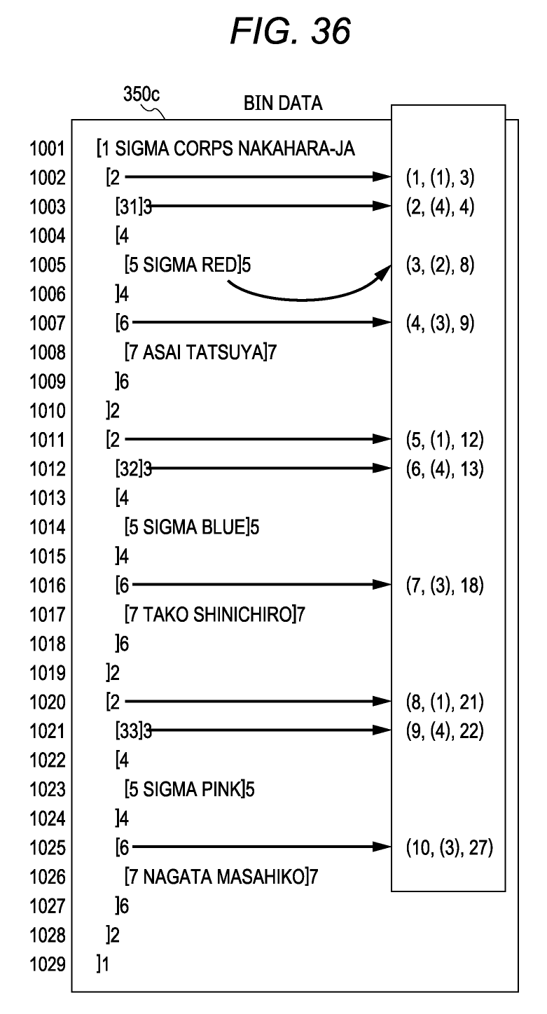

The event table creation unit 360e creates the event table 350f by sequentially substituting the BIN data 350c for the automaton shown in FIG. 35. In the following description, a process, in which the event table creation unit 360e creates the event table 350f, will be explained for positions “1001” to “1029” of the BIN data 350c of FIG. 36. FIG. 36 is a diagram explaining the process executed by the event table creation unit 360e according to embodiment 3. Note that the event table creation unit 360e uses the node ID of the node (refer to FIG. 2) when an event occurs as the value of the offset like embodiment 1.

The event table creation unit 360e substitutes data “[1 sigma corps nakahara-ja”, which corresponds to the position “1001” of the BIN data 350c, for an automaton. Thus, since a numeral which corresponds next does not exist at the stage the data goes to the node structural body 72 using the node structural body 70 as a start point, the data returns to the node structural body 70, and a search of the position “1001” is ended.

The event table creation unit 360e substitutes data “[2”, which corresponds to the position “1002” of the BIN data 350c, for the automaton. Thus, the data reaches the event structural body 80 using the node structural body 70 as a start point. At the time the data reaches the event structural 80, an event (1) (event definition ID (1)) occurs, and the event table creation unit 360e registers the event ID “1”, the event types “Z1, S”, and an offset “3” to the event table 350f. Note that the event type is specified by comparing the event definition ID with the event definition table 350e (refer to FIG. 32).

The event table creation unit 360e substitutes data “[31]3”, which corresponds to the position “1003” of the BIN data 350c, for the automaton. Thus, the data reaches the event structural body 83 using the node structure 70 as a start point. At the time the data reaches the event structural body 83, an event (4) occurs, and the event table creation unit 360e registers an event ID “2”, the event types “Z3, C”, and an offset “4” in the event table 350f.

The event table creation unit 360e substitutes data “[4”, which corresponds to the position “1004” of the BIN data 350c, for the automaton. Thus, since a numeral which corresponds next does not exist at the stage the data goes to the node structural body 72 using the node structural body 70 as a start point, the data returns to the node structural body 70, and a search of the position “1004” is ended.

The event table creation unit 360e substitutes data “[5 sigma red]5”, which corresponds to the position “1005” of the BIN data 350c, for the automaton. Thus, the data reaches the event structural body 81 using the node structural body 70 as a start point. At the time the data reaches the event structural body 81, an event (2) occurs, and the event table creation unit 360e registers the event ID “3”, the event type “A1”, and an offset “8” to the event table 350f.

The event table creation unit 360e substitutes data “]4”, which corresponds to the position “1006” of the BIN data 350c, for the automaton. Thus, the data returns to the node structural body 70 at the stage the data moves to the node structural body 71 using the node structural body 70 as a start point, and a search of the position “1006” is ended.

The event table creation unit 360e substitutes data “[6”, which corresponds to the position “1007” of the BIN data 350c, for the automaton. Thus, the data reaches the event structural body 82 using the node structural body 70 as a start point. At the time the data reaches the event structural body 82, an event (3) occurs, and the event table creation unit 360e registers an event ID “4”, the event type “Z2”, and an offset “9” to the event table 350f.

The event table creation unit 360e substitutes data “[7 asai tatsuya]7”, which corresponds to the position “1008” of the BIN data 350c, for the automaton. Thus, since a numeral which corresponds next does not exist at the stage the data goes to the node structural body 72 using the node structural body 70 as a start point, the data returns to the node structural body 70, and a search of the position “1008” is ended.

The event table creation unit 360e substitutes data “]6”, which corresponds to the position “1009” of the BIN data 350c, for the automaton. Thus, the data returns to the node structural body 70 at the stage the data moves to the node structural body 71 using the node structural body 70 as a start point, and a search of the position “1009” is ended.

The event table creation unit 360e substitutes data “[2”, which corresponds to the position “1010” of the BIN data 350c, for the automaton. Thus, the data returns to the node structural body 70 at the stage the data moves to the node structural body 71 using the node structural body 70 as a start point, and a search of the position “1010” is ended.

The event table creation unit 360e substitutes data “[2”, which corresponds to the position “1011” of the BIN data 350c, for the automaton. Thus, the data reaches the event structural body 80 using the node structural body 70 as a start point. At the time the data reaches the event structural body 80, the event (1) occurs, and the event table creation unit 360e registers the event ID “5”, the event types “Z1, S”, and an offset “12” to the event table 350f.

The event table creation unit 360e substitutes data “[32]3”, which corresponds to the position “1012” of the BIN data 350c, for the automaton. Thus, the data reaches the event structural body 83 using the node structural body 70 as a start point. At the time the data reaches the event structural body 83, the event (4) occurs, and the event table creation unit 360e registers the event ID “2”, the event types “Z3, C”, and an offset “13” to the event table 350f.

The event table creation unit 360e substitutes data “[4”, which corresponds to the position “1013” of the BIN data 350c, for the automaton. Thus, since a numeral which corresponds next does not exist at the stage the data goes to the node structural body 72 using the node structural body 70 as a start point, the data returns to the node structural body 70, and a search of the position “1013” is ended.

The event table creation unit 360e substitutes data “[5 sigma blue]5”, which corresponds to the position “1014” of the BIN data 350c, for the automaton. Thus, since a numeral which corresponds next does not exist at the stage the data goes to the node structural body 72 using the node structural body 70 as a start point, the data returns to the node structural body 70, and a search of the position “1014” is ended.

The event table creation unit 360e substitutes data “]4”, which corresponds to the position “1015” of the BIN data 350c, for the automaton. Thus, the data returns to the node structural body 70 at the stage the data moves to the node structural body 71 using the node structural body 70 as a start point, and a search of the position “1015” is ended.

The event table creation unit 360e substitutes data “[6”, which corresponds to the position “1016” of the BIN data 350c, for the automaton. Thus, the data reaches the event structural body 82 using the node structural body 70 as a start point. At the time the data reaches the event structural body 82, the event (3) occurs, and the event table creation unit 360e registers an event ID “7”, the event type “Z2”, and an offset “18” to the event table 350f.

The event table creation unit 360e substitutes data “[7 tako shinichirou]7”, which corresponds to the position “1017” of the BIN data 350c, for the automaton. Thus, since a numeral which corresponds next does not exist at the stage the data goes to the node structural body 72 using the node structural body 70 as a start point, the data returns to the node structural body 70, and a search of the position “1017” is ended.

The event table creation unit 360e substitutes data “]6”, which corresponds to the position “1018” of the BIN data 350c, for the automaton. Thus, the data returns to the node structural body 70 at the stage the data moves to the node structural body 71 using the node structural body 70 as a start point, and a search of the position “1018” is ended.

The event table creation unit 360e substitutes data “]2”, which corresponds to the position “1019” of the BIN data 350c, for the automaton. Thus, the data returns to the node structural body 70 at the stage the data moves to the node structural body 71 using the node structural body 70 as a start point, and a search of the position “1019” is ended.

The event table creation unit 360e substitutes data “[2”, which corresponds to the position “1020” of the BIN data 350c, for the automaton. Thus, the data reaches the event structural body 80 using the node structural body 70 as a start point. At the time the data reaches the event structural body 80, the event (1) occurs, and the event table creation unit 360e registers an event ID “8”, the event types “Z1, S”, and an offset “21” to the event table 350f.

The event table creation unit 360e substitutes data “[33]3”, which corresponds to the position “1021” of the BIN data 350c, for the automaton. Thus, the data reaches the event structural body 83 using the node structural body 70 as a start point. At the time the data reaches the event structural body 83, the event (4) occurs, and the event table creation unit 360e registers an event ID “9”, the event types “Z3, C”, and an offset “22” to the event table 350f.

The event table creation unit 360e substitutes data “[4”, which corresponds to the position “1022” of the BIN data 350c, for the automaton. Thus, since a numeral which corresponds next does not exist at the stage the data goes to the node structural body 72 using the node structural body 70 as a start point, the data returns to the node structural body 70, and a search of the position “1022” is ended.

The event table creation unit 360e substitutes data “[5 sigma pink]5”, which corresponds to the position “1023” of the BIN data 350c, for the automaton. Thus, since a numeral which corresponds next does not exist at the stage the data goes to the node structural body 72 using the node structural body 70 as a start point, the data returns to the node structural body 70, and a search of the position “1023” is ended.

The event table creation unit 360e substitutes data “]4”, which corresponds to the position “1024” of the BIN data 350c, for the automaton. Thus, the data returns to the node structural body 70 at the stage the data moves to the node structural body 71 using the node structural body 70 as a start point, and a search of the position “1024” is ended.

The event table creation unit 360e substitutes data “[6”, which corresponds to the position “1025” of the BIN data 350c, for the automaton. Thus, the data reaches the event structural body 82 using the node structural body 70 as a start point. At the time the data reaches the event structural body 82, the event (3) occurs, and the event table creation unit 360e registers the event ID “10”, the event type “Z2”, and an offset “27” to the event table 350f.

Note that no event occurs at the positions “1026” to “1029” of the BIN data 350c. As described above, the event table creation unit 360e creates the event table 350f by substituting the data of the positions “1001” to “1029” of the BIN data 350c for the automatons.

Returning to the explanation of FIG. 28, the query conversion processing unit 360f creates a logical expression of a query (executes a query conversion process for evaluating a query, which has a hierarchy structure and belongs to the easy class, as a flat logical expression having no hierarchy structure). When the query conversion processing unit 360f creates the logical expression for executing an evaluation from a query (hereinafter, called an evaluation logical expression), BDD (Binary Decision Diagram) and the like, which are known techniques, may be used.

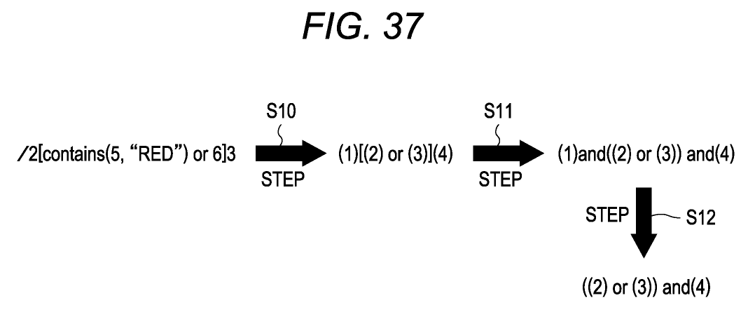

FIG. 37 is a diagram explaining a process of the query conversion processing unit 360f. Determining an evaluation logical expression of a query “2/[contains (5, “red”) or 6]3” (shown by path ID) will be explained as an example. As shown in FIG. 37, the query conversion processing unit 360f replaces a path ID (or overall “contains” function) of the query “2/[contains (5,“RED”) or 6]3” with a definition ID of an event train (step S10).

Then, the query conversion processing unit 360f creates evaluation logical expression “((2) or (3)) and (4)” by replacing the predicate's “[ ]” with “( )”, which is an auxiliary symbol of a logical expression, by inserting “and”'s (step S11), and by removing the definition ID (ordinarily (1)) corresponding to a start event (step S12). The query conversion processing unit 360f outputs information of the evaluation logical expression to the event table totaling unit 360g.

The event table totaling unit 360g totals various types of information of the event table 350f and detects positions of data (offset) corresponding to a query based on the evaluation logical expression. Then, the event table totaling unit 360g outputs information of a detected offset to the reply transmission unit 360i.

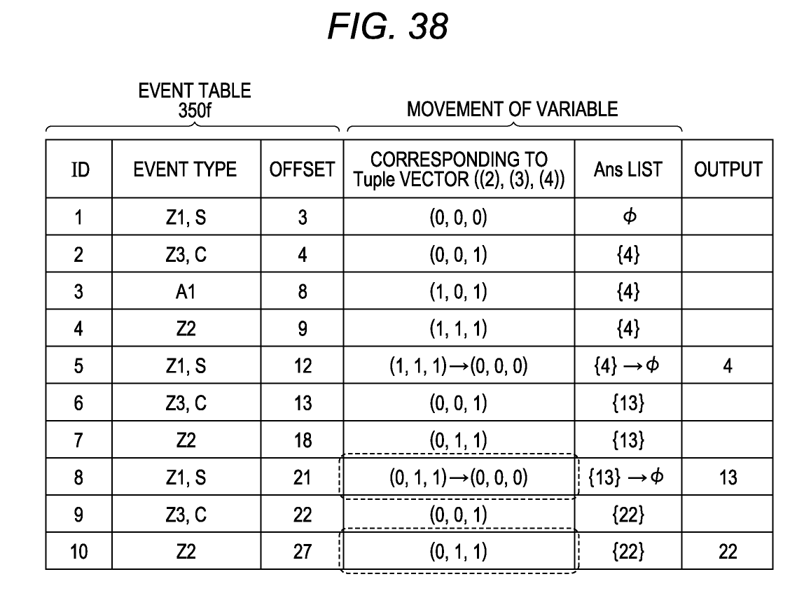

FIG. 38 is a diagram explaining a process of the event table totaling unit 360g according to embodiment 3. In FIG. 38, a bit vector (Tuple vector) is a vector for managing whether or not a given event exists.

The bit vector according to embodiment 3 manages, for example, whether or not the events (2), (3), and (4) other than the query start event S exist. Accordingly, the bit vector is arranged as a three-dimensional vector composed of first, second, and third elements. When the event (2) (corresponding to A1) exists, a bit is set to the first element. When the event (3) (corresponding to Z2) exists, a bit is set to the second element. When the event (4) (corresponding to Z3) exists, a bit is set to the third element.

While the event table totaling unit 360g totals the event table 350f, when the event table totaling unit 360g detects the event type “S” and the bit vector satisfies the evaluation logical expression, the event table totaling unit 360g outputs a value registered in the Ans list and initializes the bit vector assuming that a check position of a query is hit.

When, for example, the evaluation logical expression is the evaluation logical expressions “((2) or (3)) and (4)” shown in FIG. 37, the event table totaling unit 360g outputs the value registered in the Ans list since the evaluation logical expression is satisfied if the bit vector is set to (1, 1, 1), (1, 0, 1), or (0, 1, 1) at the time the event types “Z1” and “S” are detected.

Moving to an explanation of FIG. 38, the event table totaling unit 360g detects the event type “S” in the ID “1” of the event table 350f. However, since the evaluation logical expression is not satisfied because the bit vector is set to (0, 0, 0), the event table totaling unit 360g does not output the Ans list.

The event table totaling unit 360g detects the event types “Z3” and “C” in the ID “2” of the event table 350f. Accordingly, the event table totaling unit 360g sets the bit vector to (0, 0, 1) and registers the offset “4” in the Ans list.

The event table totaling unit 360g detects the event types “A1” in the ID “3” of the event table 350f. Accordingly, the event table totaling unit 360g sets the bit vector to (1, 0, 1).

The event table totaling unit 360g detects the event type “Z2” in the ID “4” of the event table 350f. Accordingly, the event table totaling unit 360g sets the bit vector to (1, 1, 1).

Since the event table totaling unit 360g detects the event types “Z1” and “S” in the ID “5” of the event table 350f as well as the bit vector is set to (1, 1, 1) (the evaluation logical expression is satisfied), the event table totaling unit 360g outputs a value “4” of the Ans list. Then, the event table totaling unit 360g initializes the bit vector and the Ans list.

The event table totaling unit 360g detects the event types “Z3”, “C” in the ID “6” of the event table 350f. Accordingly, the event table totaling unit 360g sets the bit vector to (0, 0, 1) and registers the offset “13” to the Ans list.

The event table totaling unit 360g detects the event type “Z2” in the ID “7” of the event table 350f. Accordingly, the event table totaling unit 360g sets the bit vector to (0, 1, 1).

As a result of detecting the event types “Z1” and “S”, the bit vector is set to (0, 1, 1) (the logical expression is satisfied) for the event table 350f ID “8”, and thus the event table totaling unit 360g outputs the Ans list value “13”. Then, the event table totaling unit 360g initializes the bit vector and the Ans list.

The event table totaling unit 360g detects the event types “Z3” and “C” in the ID “9” of the event table 350f. Accordingly, the event table totaling unit 360g sets the bit vector to (0, 0, 1) and registers the offset “22” to the Ans list.

The event table totaling unit 360g detects the event type “Z2” in an ID “10” of the event table 350f. Accordingly, the event table totaling unit 360g sets the bit vector to (0, 1, 1).

Note that since the event train ends at ID “10”, the bit vector is checked, and the Ans list is output. In an example shown in FIG. 38, since the bit vector (0, 1, 1) satisfies the evaluation logical expression, the event table totaling unit 360g outputs a value of the Ans list.

As described above, in the search apparatus 300 according to embodiment 3, the query class determination unit 360d determines whether or not a query belongs to the easy class or to the difficult class. When the query class determination unit 360d determines that the query belongs to the easy class, the event table creation unit 360e creates an automaton of the query and creates the event table 350f by substituting the BIN data 350c for an automaton. Since the event table totaling unit 360g totals the event table and searches for data corresponding to the query based on the evaluation logical expression, when the query belongs to the easy class, a load applied to the apparatus can be reduced and data search efficiency can be improved even if the evaluation logical expression is included in the query.

### Embodiment 4

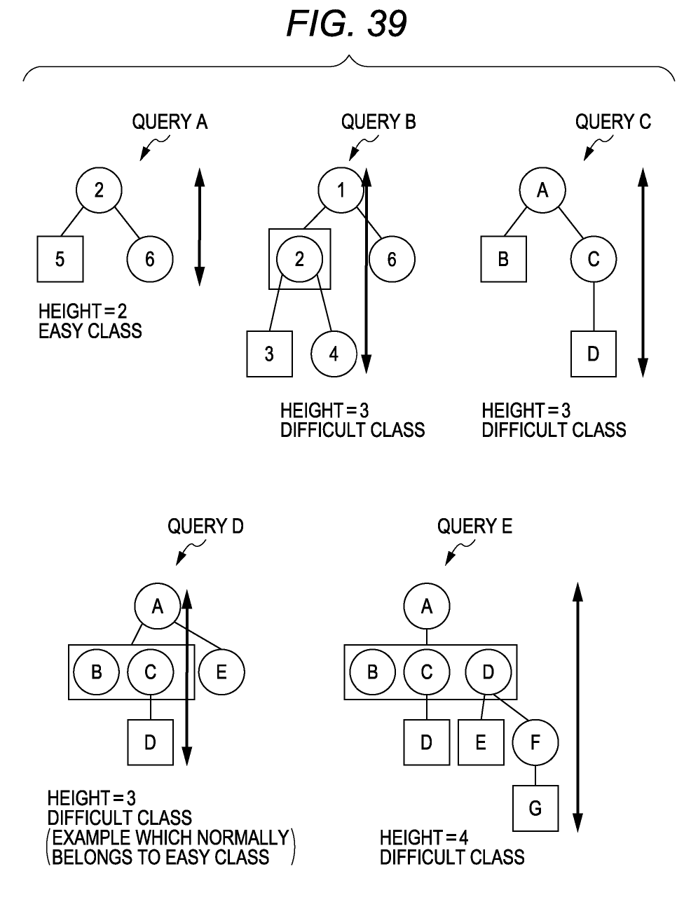

Next, a search apparatus according to embodiment 4 will be explained. The search apparatus according to embodiment 4 determines whether or not a query belongs to an easy class or to a difficult class based on a height of a query tree. FIG. 39 is a diagram explaining the height of a query tree.

The height of a query tree is defined by the number of nodes included in the longest path of the query tree. In, for example, FIG. 39, since the number of nodes included in the longest path of a query A “(Q=2[5]6)” is “2”, the height of a query tree is “2”.

Since the number of nodes included in the longest path of a query B “(Q=1[2[3]4]6)” is “3”, the height of a query tree is “3”. Since the number of nodes included in the longest path of a query C “(Q=A[B]C[D])” is “3”, the height of a query tree is “3”.

Since the number of nodes included in the longest path of a query D “(Q=/A[B or C[D]]E)” is “3”, the height of a query tree is “3”. Furthermore, since the number of nodes included in the longest path of a query E “(Q=/A[B and C[D] or E[F]G])” is “4”, the height of a query tree is “4”.

The search apparatus according to embodiment 4 determines that a query whose height of a query tree is “2 or less” belongs to the easy class and determines that the queries other than the above query belongs to the difficult class. Accordingly, in an example shown in FIG. 39, the search apparatus determines that a query A belongs to the easy class and queries B to E belong to the difficult class (note that the query D normally belongs to the easy class).

As described above, the search apparatus according to the embodiment 4 may determine whether or not a query belongs to the easy class by a method simpler than the determination based on the number of leaves although it may not be able to pick up all queries that belong to the easy class. As a result, data search efficiency by a query can be further improved.

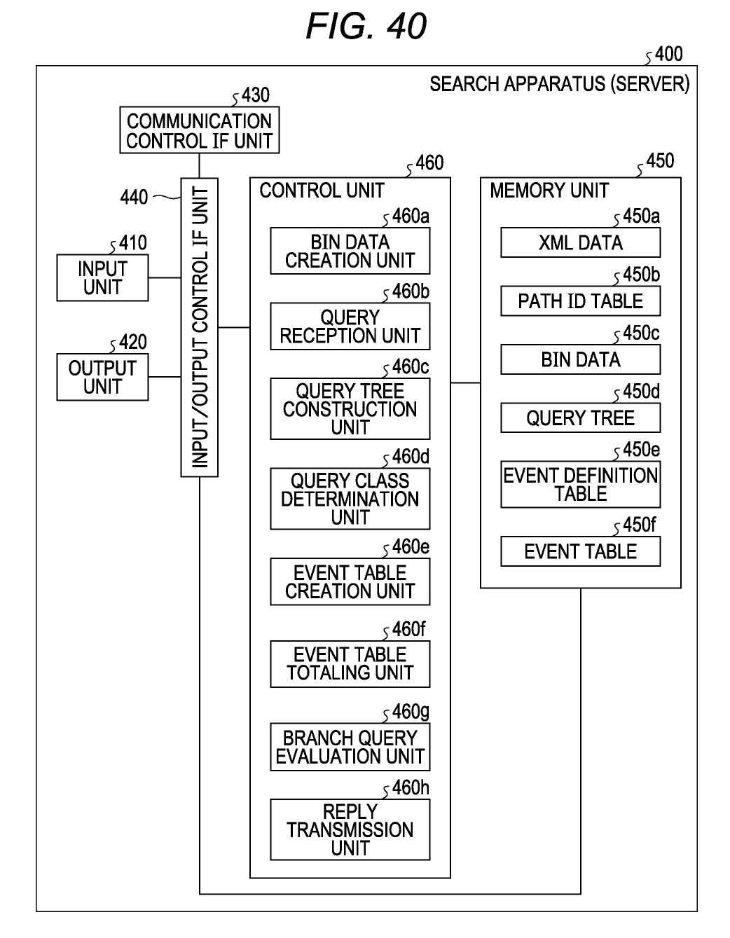

Next, a configuration of the search apparatus 400 according to embodiment 4 will be explained. FIG. 40 is a functional block diagram showing the configuration of the search apparatus 400 according to embodiment 4. As shown in the drawing, the search apparatus 400 has an input unit 410, an output unit 420, a communication control IF unit 430, an input/output control IF unit 440, a memory unit 450, and a control unit 460.

The input unit 410 inputs various types of information, is composed of a keyboard, a mouse, a microphone, and the like, and receives and inputs, for example, various types of information related to the XML data described above. Note that the monitor described below (output unit 420) may also act as a pointing device function in cooperation with the mouse.

The output unit 420 outputs various types of information, is composed of a monitor (or a display or a touch panel), a speaker, and the like, and outputs, for example, various types of information related to the XML data described above.

The communication control IF unit 430 controls communication between terminal apparatuses. The input/output control IF unit 440 controls the data input and output executed by the input unit 410, the output unit 420, the communication control IF unit 430, the memory unit 450, and the control unit 460.

The memory unit 450 stores data and programs for the control unit 460 to perform various processes and has XML data 450a, a path ID table 450b, BIN data 450c, a query tree 450d, an event definition table 450e, and an event table 450f as those particularly closely related to the present invention as shown in FIG. 40.

Since descriptions of the XML data 450a, the path ID table 450b, the BIN data 450c, the query tree 450d, the event definition table 450e, and the event table 450f are the same as those of the XML data 150a, the path ID table 150b, the BIN data 150c, the query tree 150d, the event definition table 150e, and the event table 150f shown in FIG. 4, the descriptions thereof are omitted.

The control unit 460 has an internal memory for storing a program, which prescribes various processing sequences, and control data, and executes various processes. The control unit 460 has a BIN data creation unit 460a, a query reception unit 460b, a query tree construction unit 460c, a query class determination unit 460d, an event table creation unit 460e, an event table totaling unit 460f, a branch query evaluation unit 460g, and a reply transmission unit 460h as those particularly closely related to the present invention as shown in FIG. 40.

Since descriptions of the BIN data creation unit 460a, the query reception unit 460b, the query tree construction unit 460c, the event table creation unit 460e, the event table totaling unit 460f, the branch query evaluation unit 460g, and the reply transmission unit 460h are the same as those of the BIN data creation unit 160a, the query reception unit 160b, the query tree construction unit 160c, the event table creation unit 160e, the event table totaling unit 160f, the branch query evaluation unit 160g, and the reply transmission unit 160h shown in FIG. 4, the descriptions thereof are omitted.

The query class determination unit 460d determines whether or not a query belongs to the easy class or to the difficult class based on the height of a query tree (refer to FIG. 39). Specifically, the query class determination unit 460d determines that a query whose height of a query tree is 2 or less belongs to the easy class and that a query whose height of a query tree is larger than 2 belongs to the difficult class.

Next, a processing sequence of the search apparatus 400 according to embodiment 4 will be explained. Note that since the processing sequence of the search apparatus 400 according to embodiment 4 is the same as that shown in FIG. 17, the description thereof is omitted. However, since the query class determination process shown at step S102 of FIG. 17 is different from that of the embodiment 4, a processing sequence of the query class determination process according to embodiment 4 will be explained below.

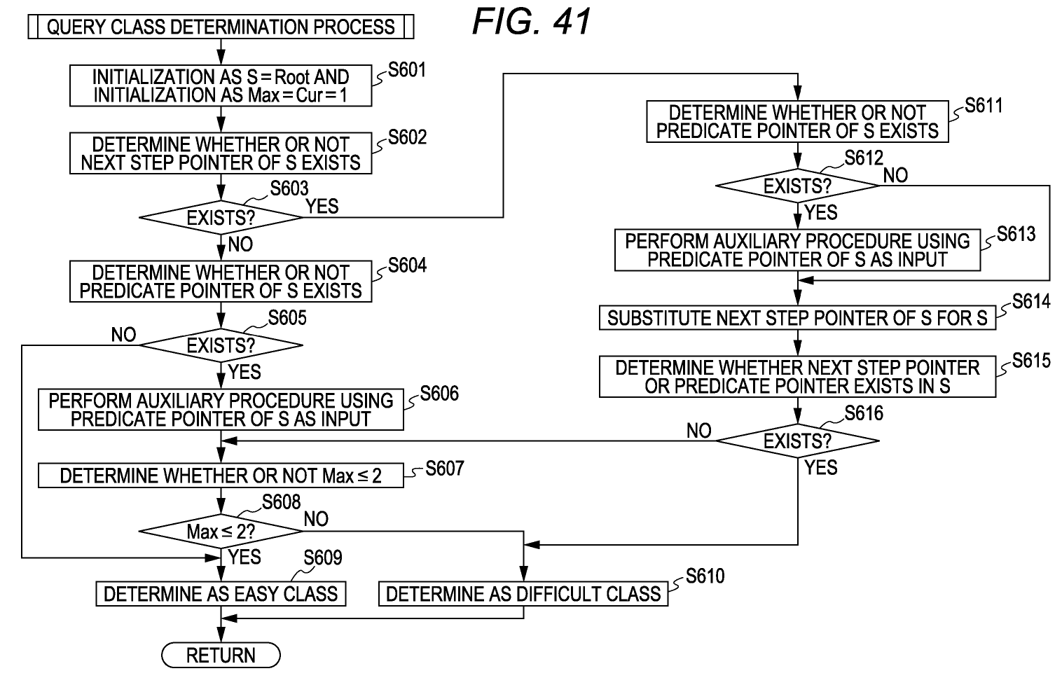

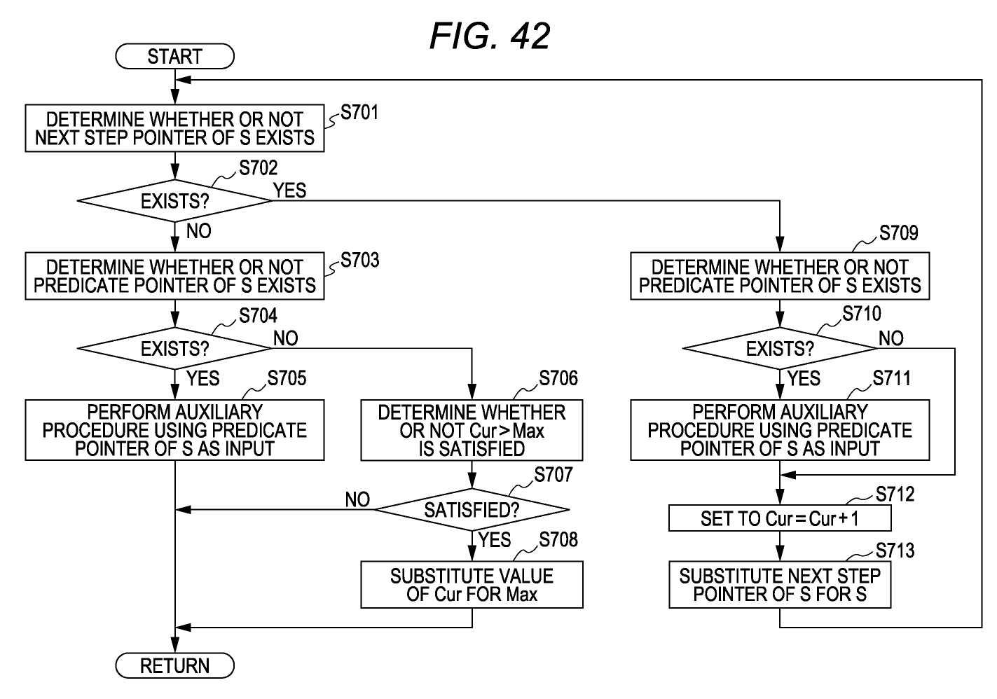

A main procedure and an auxiliary procedure exist in the query class determination process according to embodiment 4. FIG. 41 is a flowchart showing the main procedure of the query class determination process according to embodiment 4, and FIG. 42 is a flowchart showing the auxiliary procedure of the query class determination process according to embodiment 4.

As shown in FIG. 41, the query class determination unit 460d executes initialization as “S=Root” and initializes “Max” and “Cur” by setting them to 1 (step S601). Here, “Max” is a global variable, and “Cur” is a local variable.

The query class determination unit 460d determines whether or not a next step pointer of S exists (step S602), and when the next step pointer does not exist (step S603, No), the query class determination unit 460d determines whether or not a predicate pointer of S exists (step S604).

When the predicate pointer of S does not exist (step S605, No), the query class determination unit 460d goes to step S609. In contrast, when the predicate pointer of S exists (step S605, Yes), the query class determination unit 460d executes the auxiliary procedure using the predicate pointer of S as an input (step S606).

Then, the query class determination unit 460d determines whether or not a value of “Max” is 2 or less (step S607), and when the value of “Max” is 2 or less (step S608, Yes), it determines that a query belongs to the easy class (step S609). In contrast, when the value of “Max” is larger than 2 (step S608, No), the query class determination unit 460d determines that the query belongs to the difficult class (step S610).

Returning to step S603, when the next step pointer of S exists (step S603, Yes), the query class determination unit 460d determines whether or not the predicate pointer of “S” exists (step S611). When the predicate pointer of “S” does not exist (step S612, No), the query class determination unit 460d goes to step S614.

In contrast, when the predicate pointer of “S” exists (step S612, Yes), the query class determination unit 460d executes the auxiliary procedure using the predicate pointer of S as an input (step S613) and substitutes the next step pointer of “S” for “S” (step S614).

Subsequently, the query class determination unit 460d determines whether or not the next step pointer or the predicate pointer exists in S (step S615), and when one or the other exists (step S616, Yes), the query class determination unit 460d goes to step S610; whereas when neither of them exist (step S616, No), the query class determination unit 460d goes to step S607.

Next, the auxiliary procedure shown at steps S606 and S613 of FIG. 41 will be explained.

As shown in FIG. 42, the query class determination unit 460d determines whether or not the next step pointer of S exists (step S701) in the auxiliary procedure. When the next step pointer of S does not exist (step S702, No), the query class determination unit 460d determines whether or not the predicate pointer of S exists (step S703).

When the predicate pointer of S exists (step S704, Yes), the query class determination unit 460d executes the auxiliary procedure using the predicate pointer of S as an input (step S705). In contrast, when the predicate pointer of “S” does not exist (step S704, No), the query class determination unit 460d determines whether or not a value of “Cur” is larger than a value of “Max” (step S706).

Subsequently, when the value of “Cur” is not larger than the value of “Max” (step S707, No), the query class determination unit 460d finishes the auxiliary procedure as is. In contrast, when the value of “Cur” is larger than the value of “Max” (step S707, Yes), the query class determination unit 460d substitutes the value of “Cur” for “Max” (step S708) and finishes the auxiliary procedure.

Returning to the explanation of step S702, when the next step pointer of S exists (step S702, Yes), the query class determination unit 460d determines whether or not the predicate pointer of “S” exists (step S709). When the predicate pointer of S does not exist (step S710, No), the query class determination unit 460d goes to step S712.

In contrast, when the predicate pointer of S exists (step S710, Yes), the query class determination unit 460d executes the auxiliary procedure using the predicate pointer of “S” as an input (step S711), sets a value obtained by incrementing Cur by 1 as the value of Cur (step S712), substitutes the next step pointer of “S” for “S” (step S713), and goes to step S701. Note that the auxiliary procedure shown at steps S705 and S711 of FIG. 42 may be repeated.

As described above, in the search apparatus 400 according to embodiment 4, the query class determination unit 460d determines whether or not a query belongs to the easy class or to the difficult class based on the height of a query tree. Thus, when the query class determination unit 460d determines that the query belongs to the easy class, the event table creation unit 460e creates the event definition table 450e and the event table 450f. The event table totaling unit 460f totals the event table 450f to thereby search for data corresponding to the query. As a result, a load applied on the determination process for determining whether or not a query belongs to the easy class can be reduced and data search efficiency can be improved.

### Embodiment 5

Next, a case of whether or not a query belongs to an easy class or to a difficult class is determined by a height of a query (the number of nodes included in the longest path) in the second expanded example described in embodiment 3 will be explained as embodiment 5.

A search apparatus according to embodiment 5, like embodiment 4, determines that a query whose height of a query tree is 2 or less belongs to the easy class and that a query whose height of a query tree is larger than 2 belongs to the difficult class.

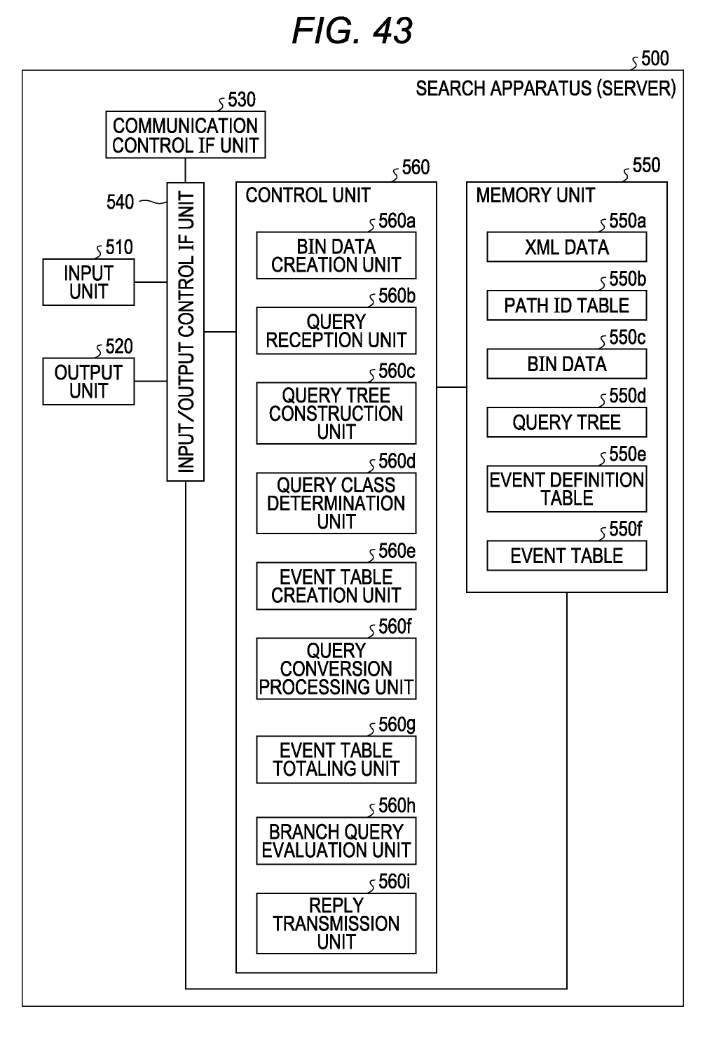

Next, a configuration of the search apparatus 500 according to embodiment 5 will be explained. FIG. 43 is a functional block diagram showing the configuration of the search apparatus 500 according to embodiment 5. As shown in the diagram, the search apparatus 500 has an input unit 510, an output unit 520, a communication control IF unit 530, an input/output control IF unit 540, a memory unit 550, and a control unit 560.

The input unit 510 inputs various types of information, is composed of a keyboard, a mouse, a microphone, and the like, and receives and inputs, for example, various types of information related to the XML data described above. Note that the monitor described below (output unit 520) may also act as a pointing device function in cooperation with the mouse.

The output unit 520 outputs various types of information, is composed of a monitor (or a display or a touch panel), a speaker, and the like, and outputs, for example, various types of information related to the XML data described above.

The communication control IF unit 530 controls communication between terminal apparatuses. The input/output control IF unit 540 controls the data input and output executed by the input unit 510, the output unit 520, the communication control IF unit 530, the memory unit 550, and the control unit 560.

The memory unit 550 stores data and programs for the control unit 560 to perform various processes and has XML data 550a, a path ID table 550b, BIN data 550c, a query tree 550d, an event definition table 550e, and an event table 550f as those particularly closely related to the present invention as shown in FIG. 43.

Since descriptions of the XML data 550a, the path ID table 550b, the BIN data 550c, the query tree 550d, the event definition table 550e, and the event table 550f are the same as those as to the XML data 350a, the path ID table 350b, the BIN data 350c, the query tree 350d, the event definition table 350e, and the event table 350f shown in FIG. 28, the descriptions thereof are omitted.

The control unit 560 has an internal memory for storing a program, which prescribes various processing sequences, and control data, and executes various processes with them. The control unit 560 has a BIN data creation unit 560a, a query reception unit 560b, a query tree construction unit 560c, a query class determination unit 560d, an event table creation unit 560e, a query conversion processing unit 560f, an event table totaling unit 560g, a branch query evaluation unit 560h, and a reply transmission unit 560i as those particularly closely related to the present invention as shown in FIG. 43.

Since descriptions of the BIN data creation unit 560a, the query reception unit 560b, the query tree construction unit 560c, the event table creation unit 560e, the query conversion processing unit 560f, the event table totaling unit 560g, the branch query evaluation unit 560h, and the reply transmission unit 560i are the same as those of the BIN data creation unit 360a, the query reception unit 360b, the query tree construction unit 360c, the event table creation unit 360e, the query conversion processing unit 360f, the event table totaling unit 360g, the branch query evaluation unit 360h, and the reply transmission unit 360i shown in FIG. 28, the descriptions thereof are omitted.

The query class determination unit 560d determines whether or not a query belongs to the easy class or another class based on a height of a query tree (refer to FIG. 39). Specifically, the query class determination unit 560d determines that a query whose height of a query tree is “2” or less belongs to the easy class and that a query whose height of a query tree is larger than “2” belongs to the difficult class. Note that a method of calculating a height of a query tree will be explained below.

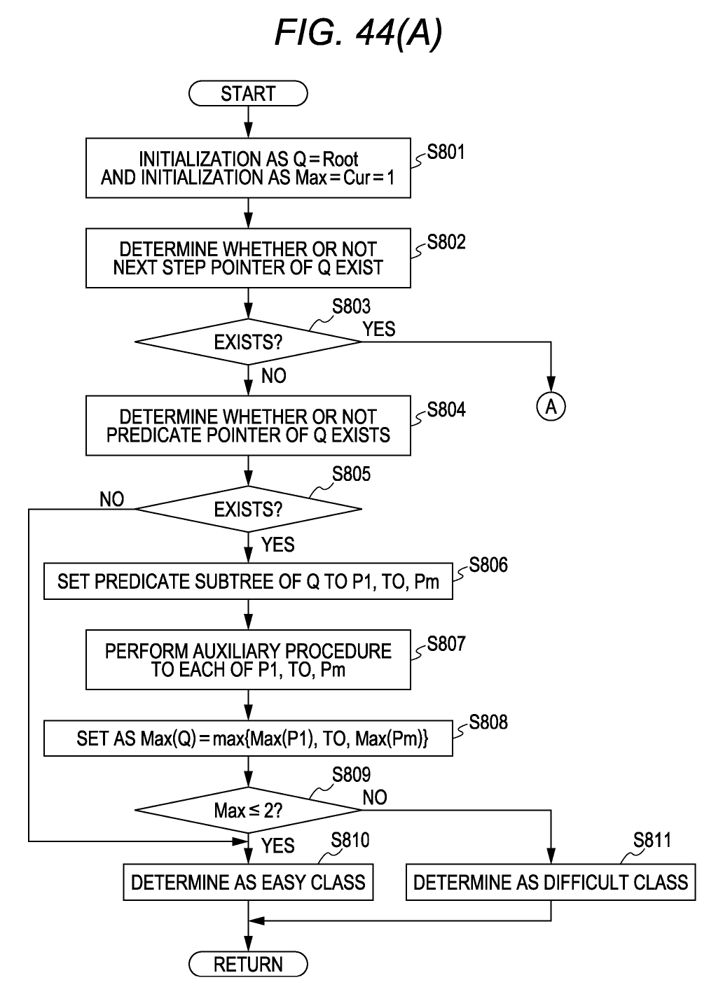

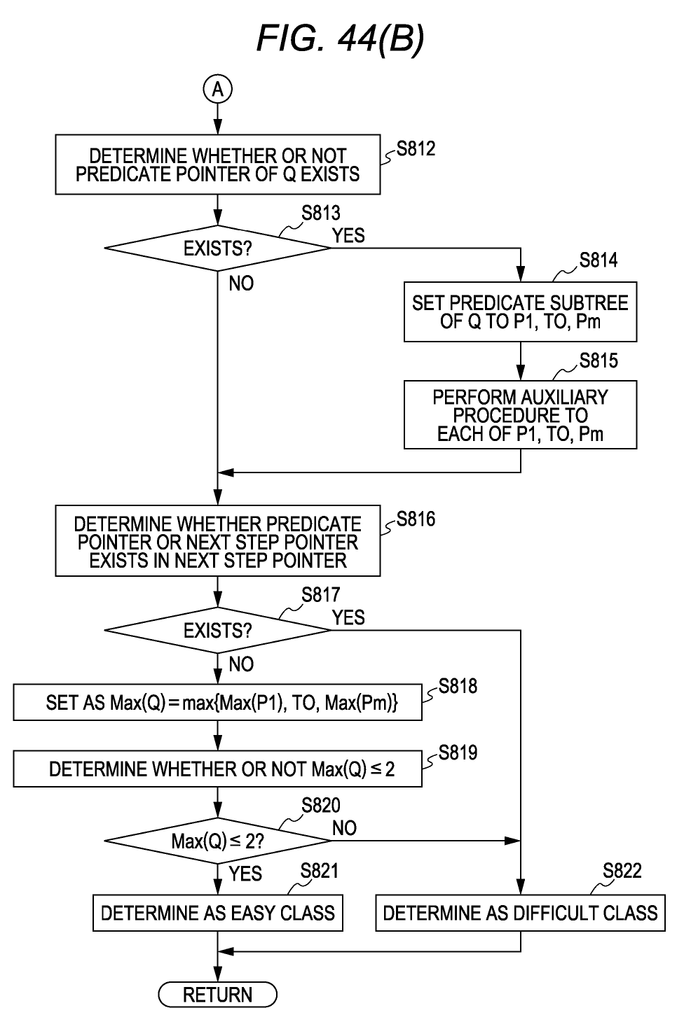

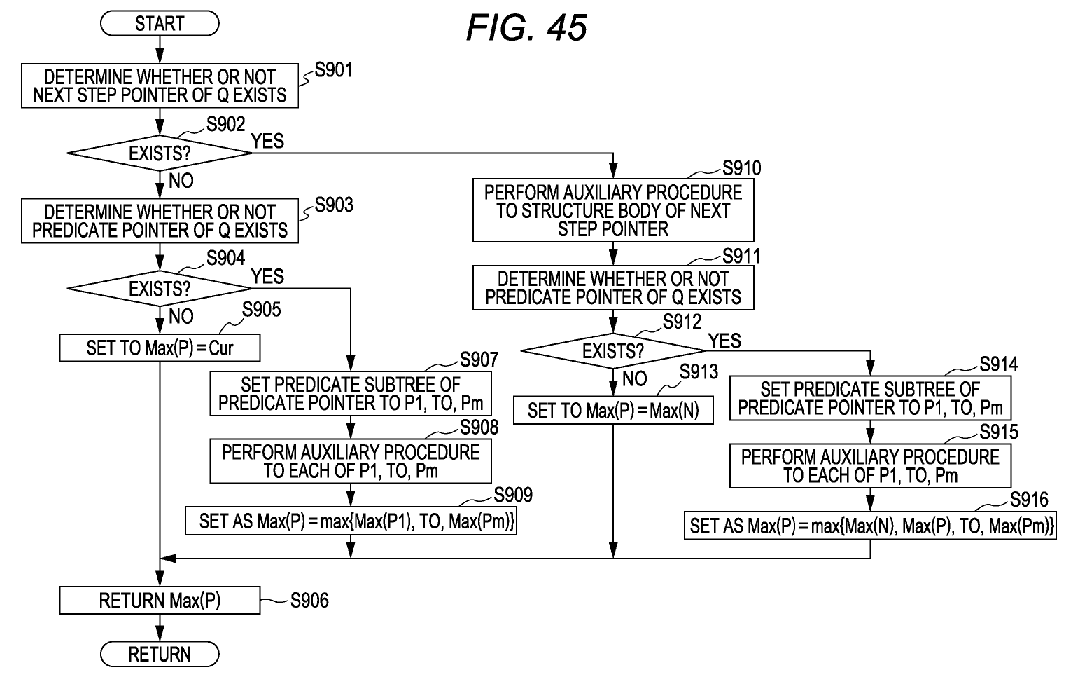

Next, a query class determination process executed by the query class determination unit 560d will be explained. A main procedure and an auxiliary procedure exist in the query class determination process according to embodiment 5. FIGS. 44(A) and 44(B) are flowcharts showing the main procedure of the query class determination process according to embodiment 5. FIG. 45 is a flowchart showing the auxiliary procedure of the query class determination process according to embodiment 5.

As shown in FIGS. 44(A) and 44(B), the query class determination unit 560d executes initialization as “Q=Root” and initializes “Max” and “Cur” by setting them to “1” (step S801). Here, “Max” is a global variable, and “Cur” is a local variable.

The query class determination unit 560d determines whether or not a next step pointer of “Q” exists (step S802), and when the next step pointer of “Q” does not exist (step S803, No), the query class determination unit 560d determines whether or not a predicate pointer of “Q” exists (step S804).

When the predicate pointer of “Q” does not exist (step S805, No), the query class determination unit 560d goes to step S810. In contrast, when the predicate pointer of “Q” exists (step S805, Yes), the query class determination unit 560d sets a predicate subtree of “Q” to “P1 to Pm” (step S806).

Subsequently, the query class determination unit 560d executes the auxiliary procedure for each of “P1 to Pm” (step S807) and sets “Max(Q)=max{Max(P1) to Max(Pm)}” (step S808).

When a value of “Max” is “2” or less (step S809, Yes), the query class determination unit 560d determines that a query belongs to the easy class (step S810). In contrast, when a value of “Max” is larger than “2” (step S809, No), the query class determination unit 560d determines that a query belongs to the difficult class (step S811).

Returning to the explanation of step S803, when the next step pointer of “Q” exists (step S803, Yes), the query class determination unit 560d determines whether or not the predicate pointer of “Q” exists (step S812), and when the predicate pointer of “Q” does not exist (step S813, No), the query class determination unit 560d goes to step S816.

In contrast, when the predicate pointer of “Q” exists (step S813, Yes), the query class determination unit 560d sets the predicate subtree of Q to “P1 to Pm” (step S814), executes the auxiliary procedure to each of “P1 to Pm” (step S815), and determines whether or not a predicate pointer or a next step pointer exists in the next step pointer (step S816).

When the next step pointer or the predicate pointer exists (step S217, Yes), the query class determination unit 560d goes to step S822. In contrast, when the next step pointer or the predicate pointer does not exist (step S817, No), the query class determination unit 560d sets “Max(Q)=max{Max(P1) to Max(Pm)}” (step S818).

The query class determination unit 560d determines whether or not a value of Max(Q) is 2 or less (step S819). When the value of Max(Q) is 2 or less (step S820, Yes), the query class determination unit 560d determines that a query belongs to the easy class (step S821). In contrast, when a value of “Max(Q)” is larger than “2” (step S820, No), the query class determination unit 560d determines that a query belongs to the difficult class (step S811).

Next, the auxiliary procedure shown at step S807 of FIG. 44(A) and at step S815 of FIG. 44(B) will be explained.

As shown in FIG. 45, the query class determination unit 560d determines whether or not the next step pointer of “Q” (predicate subtree) exists (step S901), and when the next step pointer of “Q” does not exist (step S902, No), the query class determination unit 560d determines whether or not the predicate pointer of “Q” exists (step S903).

When the predicate pointer of “Q” does not exist (step S904, No), the query class determination unit 560d sets a value of “Max(P)” to a value of “Cur” (step S905) and the value of “Max(P)” is returned to the process in Step S816 (step S906).

In contrast, when the predicate pointer of “Q” exists (step S904, Yes), the query class determination unit 560d sets the predicate subtree of the predicate pointer to “P1 to Pm” (step S907), executes the auxiliary procedure to each of “P1 to Pm” (step S908), sets “Max(P)=max{Max(P1) to Max(Pm)}” (step S909), and goes to step S906.

Returning to the explanation of step S902, when the next step pointer of “Q” exists (step S902, Yes), the query class determination unit 560d executes the auxiliary procedure on a structural body of the next step pointer (step S910) and determines whether or not the predicate pointer of “Q” exists (step S911).

When the predicate pointer of Q does not exist (step S912, No), the query class determination unit 560d sets a value of “Max(N)” (value of Max according to the structural body of the next step pointer) to a value of “Max(P)” (step S913), and goes to step S906.

In contrast, when the predicate pointer of “Q” exists (step S912, Yes), the query class determination unit 560d sets the predicate subtree of the predicate pointer to “P1 to Pm” (step S914) and executes the auxiliary procedure for each of “P1 to Pm” (step S915).

Then, the query class determination unit 560d sets “Max(P)=max{Max(N), Max(P1) to Max(Pm)}” (step S916) and goes to step S906. Note that the auxiliary procedure shown at steps S908, S910, and S915 of FIG. 45 may be repeated.

As described above, in the search apparatus 500 according to embodiment 5, the query class determination unit 560d determines whether or not a query belongs to the easy class or to the difficult class based on the height of a query tree. When the query class determination unit 560d determines that the query belongs to the easy class, the event table creation unit 560e creates an automaton of the query and creates the event table 550f by substituting the BIN data 550c for an automaton, and the event table totaling unit 560g totals the event table and searches for data corresponding to the query based on an evaluation logical expression. As a result, even if the evaluation logical expression is included in the query, a determination can be made efficiently as to whether or not the query belongs to the easy query, a load applied to the apparatus can be reduced, and data search efficiency can be improved.

Note that in embodiments 1 to 5 described above, the present embodiments are applied to data and a query described based on the data describing method (XML) and the query describing method (X-Path) determined by W3C as an example. However, the present embodiments are not limited thereto and can be also applied to, for example, “document data having a hierarchy structure” and “a query having a hierarchy structure” which are not applicable to a specification of W3C.

All or a part of the respective processes, which are explained as the processes that are automatically executed in the embodiments, can be also manually executed; and all or a part of the respective processes, which are explained as the processes that are manually executed in the embodiments, can be also automatically executed by a known method. In addition, information, which includes processing sequences, control sequences, specific names, and various types of data and parameters shown in the above description and drawings, can be arbitrarily changed except where specified particularly.

The respective components of the search apparatuses 100, 200, and 300 shown in FIGS. 4, 22, and 28 are shown by functional concepts and are not necessarily arranged physically as shown in the diagrams. That is, specific modes for dispersing and integrating the respective apparatuses are not limited to the illustrated ones, and all or a part of the respective apparatuses may be functionally or physically dispersed or integrated in arbitrary units according to various types of loads and states of use. Furthermore, all or a part of the respective processing functions executed in the respective apparatuses may be realized by a CPU and a program that is analyzed and executed by the CPU, or may be realized as hardware executed by a wired logic.

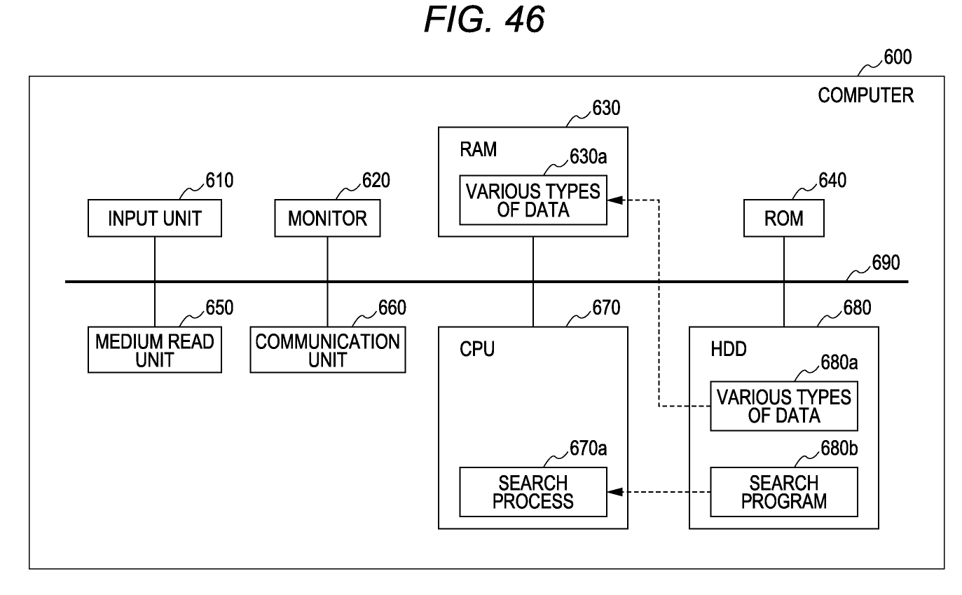

Here, as an example, a hardware configuration of a computer of the search apparatus 100 according to embodiment 1 will be explained. FIG. 39 is a diagram showing the hardware configuration of the computer constituting the search apparatus 100 according to embodiment 1. As shown in FIG. 46, the computer (search apparatus) 600 is composed of an input unit 610, a monitor 620, a RAM (Random Access Memory) 630, a ROM (Read Only Memory) 640, a medium read unit 650 for reading data from a storage medium, a communication unit 660 for transmitting and receiving data between other apparatuses (terminal apparatuses), a CPU (Central Processing Unit) 670, and a HDD (Hard Disk Drive) 680 which are connected to each other by a bus 690.

The HDD 680 stores a search program 680b which exhibits functions similar to those of the search apparatus 100 described above. The search process 670a is started by the CPU 670 which reads out and executes the search program 680b. The search process 670a corresponds to the BIN data creation unit 160a, the query reception unit 160b, the query tree construction unit 160c, the query class determination unit 160d, the event table creation unit 160e, the event table totaling unit 160f, the branch query evaluation unit 160g, and the reply transmission unit 160h of FIG. 4.

Furthermore, the HDD 680 stores various types of data 680a that correspond to the XML data 150a, the path ID table 150b, the BIN data 150c, the query tree 150d, the event definition table 150e, and the event table 150f shown in FIG. 4. The CPU 670 reads out the various types of data 680a stored in the HDD 680, stores the various types of data in the RAM 630, and searches for data corresponding to a query using various types of data 630a stored in the RAM 630.

The search program 680b shown in FIG. 46 is not necessarily stored in the HDD 680 from the beginning. The search program 680b may be stored, for example, in a portable physical medium such as a flexible disc (FD), a CD-ROM, a DVD disc, an optical magnetic disc, or an IC card that are inserted into the computer, or in a fixed physical medium such as a hard disc drive (HDD) and the like disposed internally or externally of the computer, or furthermore in another computer (or server) and the like connected to the computer through a public network, the Internet, LAN, WAN, and the like, and the other computer may read out and execute the search program 680b.

What is claimed is:

1. A search method of causing a computer to execute the search method of searching for and retrieving, when a search formula to document data having a hierarchy structure whose elements are delimited by an element identifier is obtained, data corresponding to the search formula from the document data, comprising:
storing, when the search formula is obtained, the search formula in a memory device;
determining, when searching for and retrieving the data corresponding to the search formula from the document data, whether or not a hierarchy management is necessary for the search formula based on the search formula; and
searching for and retrieving, when the determining determines that the hierarchy management is not necessary for the search formula, the data corresponding to the search formula from the document data without executing the hierarchy management.

2. The search method according to claim 1, wherein when the determining determines that the hierarchy management is not necessary for the search formula, the searching for and retrieving the data corresponding to the search formula from the document data by creating a binary data, in which the respective element identifiers included in the document data are converted into unique identification information, and determining whether or not the binary data coincides with the search formula.

3. The search method according to claim 1, wherein, when a tree structure of the search formula has one terminal node, the determining determines that the hierarchy management is not necessary.

4. The search method according to claim 1, wherein, when the tree structure of the search formula has two terminal nodes and a node, which is connected by a pointer of the terminal node acting as a second step, does not exist, the determining determines that the hierarchy management is not necessary.

5. The search method according to claim 1, wherein, when the determining determines the number of nodes included in the longest path of the search formula and the number of the nodes is equal to or less than a given value, the determining determines that the hierarchy management is not necessary.

6. The search method according to claim 2, wherein, when the search formula includes a logical expression condition, the search step evaluates the logical expression condition and searches for and retrieves the data corresponding to the search formula from the document data based on whether or not the binary data coincides with the search formula and on the logical expression condition.

7. A search apparatus for searching for and retrieving, when a search formula for document data having a hierarchy structure whose elements are delimited by an element identifier is obtained, data corresponding to the search formula from the document data, comprising:
determination unit determines, when the data corresponding to the search formula is searched for and retrieved from the document data, whether or not a hierarchy management is necessary for the search formula based on the search formula; and
search units searches for and retrieves, when the determination unit determines that the hierarchy management is not necessary for the search formula, the data corresponding to the search formula from the document data without executing the hierarchy management.

8. The search apparatus according to claim 7, wherein when the determination unit determines that the hierarchy management is not necessary for the search formula, the search unit searches for and retrieves the data corresponding to the search formula from the document data by creating a binary data, in which the respective element identifiers included in the document data are converted into unique identification information, and determines whether or not the binary data coincides with the search formula.

9. The search apparatus according to claim 7, wherein when a tree structure of the search formula has one terminal node, the determination unit determines that the hierarchy management is not necessary.

10. The search apparatus according to claim 7, wherein when the tree structure of the search formula has two terminal nodes and a node, which is connected by a pointer of the terminal node acting as a second step, does not exist, the determination unit determines that the hierarchy management is not necessary.

11. The search apparatus according to claim 7, wherein when the determination unit determines the number of nodes included in the longest path of the search formula and the number of the nodes is equal to or less than a given value, the determination unit determines that the hierarchy management is not necessary.

12. The search apparatus according to claim 8, wherein when the search formula includes a logical expression condition, the search unit evaluates the logical expression condition and searches for and retrieves the data corresponding to the search formula from the document data based on a result of determination whether or not the binary data coincides with the search formula and on a result of evaluation of the logical expression condition.
